(19) United States
(12) Patent Application Publication
(10) Pub. No.: US 2024/0017300 A1
(43) Pub. Date: Jan. 18, 2024

(54) ULTRASONIC LENS CLEANING SYSTEM WITH CALIBRATION

(71) Applicant: TEXAS INSTRUMENTS INCORPORATED, Dallas, TX (US)

(72) Inventors: David Magee, Allen, TX (US); James Griffin, Garland, TX (US)

(21) Appl. No.: 17/866,329

(22) Filed: Jul. 15, 2022

(51) Int. Cl. B08B 7/02; B06B 1/02; B06B 1/06; G02B 27/00

(52) U.S. Cl. CPC B08B 7/028; B06B 1/0276; B06B 1/0644; G02B 27/0006

(57) ABSTRACT

In one example, an apparatus comprises: a transducer, a driver circuit coupled to the transducer, a memory, and a controller. The memory is configured to store a power profile, the power profile including a mapping between power metrics and oscillation frequencies of the transducer, the power metrics being indicative of a power delivered to the transducer. The controller is coupled to the memory and the driver circuit, the controller configured to: obtain the power profile from the memory; determine a frequency of a driver signal based on the power profile; and provide the driver signal having the frequency to the driver circuit.

### CROSS-REFERENCE TO RELATED APPLICATIONS

The present application is related to: (a) U.S. Pat. No. 10,663,418, titled “Transducer temperature sensing”, issued on May 26, 2020, (b) U.S. Pat. No. 10,682,675, titled “Ultrasonic lens cleaning system with impedance monitoring to detect faults or degradation”, issued on Jun. 16, 2020; (c) U.S. Pat. No. 11,237,387, titled “Ultrasonic lens cleaning system with foreign material detection”, issued on Feb. 1, 2022, and (d) U.S. patent application Ser. No. 17/865,710, titled “METHODS AND APPARATUS OF POWER REGULATION FOR A TRANSDUCER”, Attorney Docket Number T101521US01, filed on Jul. 15, 2022, all of which are hereby incorporated herein by reference in their entireties.

### BACKGROUND

Camera systems are becoming more prevalent in automotive and other applications, such as vehicle cameras, security cameras, industrial automation systems, and in other applications and end-use systems. Operation of camera and lighting systems is facilitated by clean optical paths, which can be hindered by dirt, water or other debris, particularly in outdoor applications such as vehicle mounted camera systems, outdoor security camera systems, camera systems in industrial facilities, etc.

Automatic lens cleaning systems (LCSs) have been developed for vehicle and security cameras to self-clean a lens or lens cover. Such systems may vibrate the lens to expel contaminants, water or other unwanted material from the lens to improve image quality or light transmission efficiency. To improve the efficiency of the cleaning operation, the LCS may vibrate the lens at a resonant frequency to reduce the amount of power used in achieving a certain amplitude of lens vibration.

### SUMMARY

An apparatus comprises: a transducer; a driver circuit, a memory, and a controller. The memory is configured to store a power profile, the power profile including a mapping between power metrics and oscillation frequencies of the transducer, the power metrics being indicative of a power delivered to the transducer. The controller is coupled to the memory and the driver circuit. The controller is configured to: obtain the power profile from the memory; determine a frequency of a driver signal based on the power profile; and provide a driver signal having the frequency to the driver circuit.

A method comprises determining an operation to be performed by a lens cleaning system. The method further comprises based on the operation, accessing one of a power profile or an impedance profile of the lens cleaning system. The power profile includes a first mapping between power metrics and oscillation frequencies of a transducer of the lens cleaning system, the power metrics being indicative of a power delivered to the transducer. The impedance profile includes a second mapping between impedances and the oscillation frequencies of the transducer. The method further comprises determining a driving frequency of the transducer of the lens cleaning system from the one of the power profile or the impedance profile, and driving the transducer at the driving frequency.

A method comprises driving a transducer of a lens cleaning system at one or more frequencies. The method further comprises generating at least one of: a first measurement of a current through the transducer when the transducer vibrates at the one or more frequencies, or a second measurement of a voltage across the transducer when the transducer vibrates at the one or more frequencies. The method further comprises computing operation metrics based on at least one of the first or second measurements, and generating a metric profile by mapping the operation metrics to the one or more frequencies.

### BRIEF DESCRIPTION OF THE DRAWINGS

FIG. 1 is a schematic diagram of an example camera lens assembly.

FIG. 2 is a schematic diagram of an example lens cleaning system that can be part of the example camera lens assembly of FIG. 1.

FIG. 3 and FIG. 4 are schematic diagrams of example driver circuits of the example lens cleaning system of FIG. 2.

FIG. 5 are waveform diagrams that illustrate example operations of the driver circuit of FIGS. 3 and 4.

FIG. 6A and FIG. 6B are schematic diagrams of example impedance profile to support the operations of the lens cleaning system of FIG. 2.

FIG. 7 include waveform diagrams that illustrate example resonant frequency shift of a combined load of a transducer and a filter circuit of the lens cleaning system of FIG. 2.

FIG. 8 include waveform diagrams that illustrate resonant frequency shift caused by component variations of the lens cleaning system of FIG. 2.

FIG. 9 is a schematic diagram of another example lens cleaning system that operates on a power profile.

FIG. 10A and FIG. 10B are schematic diagrams of an example power profile and an example combined power and impedance profile.

FIG. 11, FIG. 12, FIG. 13, and FIG. 14 are diagrams that illustrate example metrics included in a power profile.

FIG. 15 is a flowchart of an example method of performing a lens cleaning operation.

FIGS. 16A through 16E illustrate a flowchart of an example method of operating a lens cleaning system to support multiple detection operations.

FIG. 17 is a flowchart of an example method of calibrating a lens cleaning system.

FIG. 18 is a schematic diagram of a hardware computing system that can be part of lens cleaning system of FIGS. 2 and 9.

The same reference numbers or other reference designators are used in the drawings to designate the same or similar (functionally and/or structurally) features.

### DETAILED DESCRIPTION

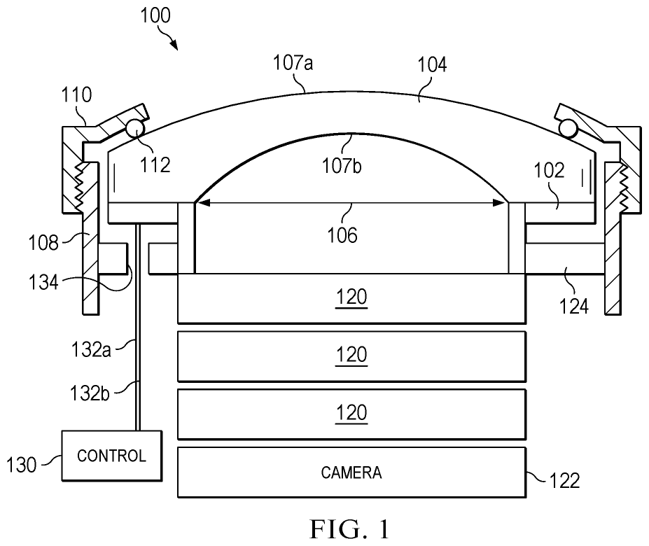

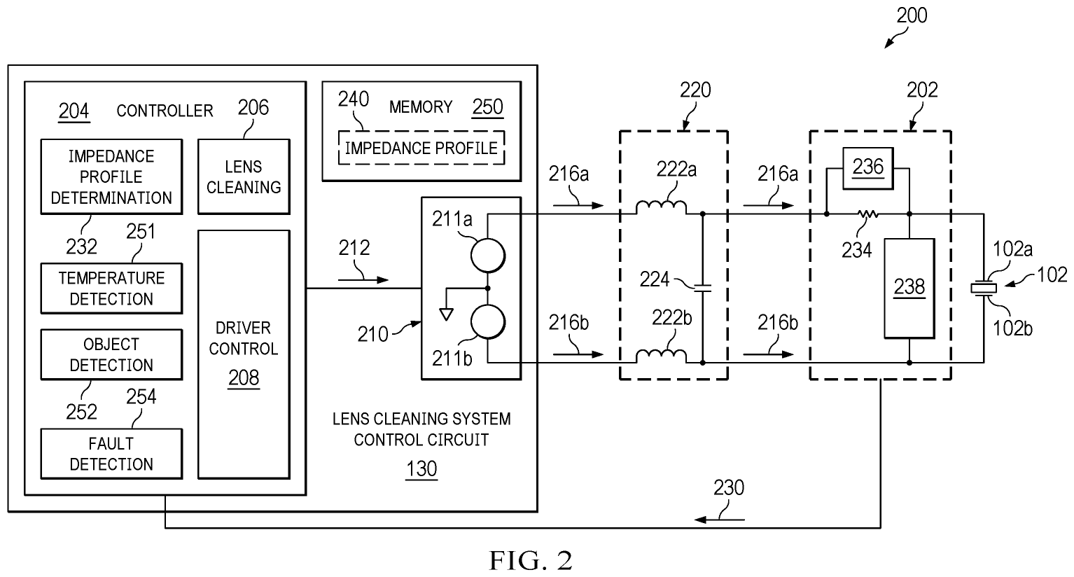

FIG. 1 is a schematic diagram of an example camera lens assembly 100. Referring to FIG. 1, lens assembly 100 includes a transducer 102 that is mechanically coupled to a lens 104. In other embodiments, structure 104 is a lens cover that is spaced away from the camera lens (such as lens 120). For ease, structure 104 is referred to herein as a “lens”, but this term is intended to address the camera lens and/or a lens cover (as illustrated in FIG. 1). In the example of FIG. 1, lens 104 can have a curved outer lens surface 107a and a curved inner lens surface 107b at aperture 106. In some examples, one or more of outer lens surface 107a or inner lens surface 107b can include a flat surface. Also, transducer 102 can be in the form of a ring around an aperture 106 of lens 104, and can be bonded to a periphery of lens 104. In some examples, transducer 102 can include a piezo-electric material that can undergo physical deformation in response to a direction of an electrical field across transducer 102.

In some examples, lens 104 can be mounted to a housing 108 via a cap fastener 110, and the space between lens 104 and housing 108/cap fastener 110 can be sealed with a ring (e.g., an O-ring) 112, to prevent water or other object from entering housing 108. Lens assembly may also include one or more lenses 120 and a camera 122 in housing 108. Lenses 104 and 120 can form a stack of lens to provide an optical path through aperture 106 for an imaging operation by camera 122. Lenses 120 and camera 122 can be mechanically coupled to housing 108 via spacers 124, which can provide mechanical support to lenses 120 and camera 122. In some examples, camera 122 may include a photo diode.

Also, lens assembly 100 can include a control circuit 130 to control the operation of transducer 102. Control circuit 130 can be electrically coupled to the electrodes (not shown in FIG. 1) of transducer 102 via conductors (e.g., wires) 132a and 132b, which can extend through an opening 134 of spacer 124. Control circuit 130 can provide an alternating current (AC) electrical signal (e.g., a voltage signal or a current signal) across the electrodes of transducer 102, which can create an electric field that switches directions in response to the AC electrical signal. In other examples, control circuit 130 may provide excitation signals to transducer 102 that utilize different signaling technology (e.g., pulse-width modulation (PWM), on-off keying modulation (OOK), etc., where an excitation signal is modulated by a carrier frequency). Transducer 102 can contract and expand alternatively in response to the electric field and generate a vibration at both transducer 102 and lens 104. The vibration can be repeated as part of a lens cleaning operation to remove an object (e.g., water droplet and dirt) from outer lens surface 107a. In some examples, control circuit 130 can include one or more integrated circuits (ICs). As to be described below, control circuit 130 and transducer 102 can be part of an automatic lens cleaning system (LCS). Control circuit 130 can detect an object on outer lens surface 107a and, responsive to detecting the object, transmit electrical signals to drive transducer 102 to oscillate/vibrate. The oscillation of transducer 102 also causes lens 104 to vibrate, and the vibration of lens 104 can move/expel the object away from outer lens surface 107a. Also, in some examples, control circuit 130 can detect a fault condition in the LCS, and provide a signal via an output device (not shown in FIG. 1) to indicate the fault condition.

FIG. 2 is a schematic diagram of example internal components of a lens cleaning system 200 that can be part of lens assembly 100. Referring to FIG. 2, lens cleaning system 200 can include control circuit 130, transducer 102, and a sensor circuit 202. Control circuit 130 can include a controller 204 (which includes lens cleaning circuitry 206, also referred to herein as lens cleaning module 206), a driver control module 208, and a driver circuit 210. In some examples, controller 204 can include a microcontroller configured to execute software instructions, and a module can include software instructions to be executed by the microcontroller to perform an operation. In some examples, controller 204 can include an application specific integrated circuit (ASIC), a logic circuit such as a field array programmable logic (FPGA), digital circuitry, analog circuitry, clocking circuitry, analog-to-digital converter (ADC), digital-to-analog converter (DAC), a state machine, memory, a processor and/or software. The lens cleaning module can include analog and/or digital circuitries configured to perform an operation.

Specifically, lens cleaning module 206 can perform a lens cleaning operation, in which lens cleaning module 206 drives transducer 102, via driver control module 208 and driver circuit 210, to vibrate lens 104 to remove/expel an object on outer lens surface 107a. Driver control module 208 can include a signal generator (e.g., a PWM signal generator, a DAC signal, etc.), which can be controlled by lens cleaning module 206 to provide a control signal 212 to driver circuit 210. Driver circuit 210 can include a pair of signal sources 211a and 211b, which can provide a pair of driver signals 216a and 216b at respective electrodes/terminals 102a and 102b of transducer 102 responsive to control signal 212. In some examples, signal sources 211a and 211b can be voltage sources to provide voltage signals as driver signals 216a and 216b. In some examples, signal sources 211a and 211b can be current sources to provide current signals as driver signals 216a and 216b.

In some examples, driver signals 216a and 216b can be continuous wave signals having opposite polarities (e.g., signals 216a and 216b may be approximately 180° out of phase), and control signal 212 can set the frequency of driver signals 216a and 216b. Driver signals 216a and 216b can create an electric field that switches direction in each cycle of driver signals 216a and 216b between electrodes 102a and 102b. Transducer 102 can contract and expand alternatively in response to the electric field, and generate a mechanical vibration/oscillation at both transducer 102 and lens 104. The frequency of the mechanical vibration/oscillation can be set by the frequency of driver signals 216a and 216b.

In some examples, each of driver signals 216a and 216b can be a sinusoidal signal having a frequency equal to a resonant frequency of transducer 102. Transducer 102 may include one or more resonant frequencies within one or more frequency ranges, and the impedance of transducer 102 at a resonant frequency can be at a minimum within a particular frequency range. Providing driver signals 216a and 216b at a resonant frequency of transducer 102 can maximize (or at least increase) the amount of power transferred to transducer 102, which can also maximize/increase the amplitude of vibration of lens 104 within a particular frequency range. Such arrangements can improve the power efficiency of lens cleaning system 200 in removing objects (e.g., water and dirt) from outer lens surface 107a.

In some examples, lens cleaning system 200 can include a filter circuit 220 coupled between driver circuit 210 and transducer 102. Filter circuit 220 can be a low pass filter including inductors 222a and 222b and a capacitor 224. Filter circuit 220 can have a corner frequency based on the resonant frequency of transducer 102. Filter circuit 220 can perform a low pass filtering operation on driver signals 216a and 216b, and provide the filtered driver signals to transducer 102. The low pass filtering operation can retain the component of driver signals 216a and 216b having the resonant frequency, and remove/attenuate components of driver signals 216a and 216b having frequencies higher than the resonant frequency. The filtered driver signals 216a and 216b can be a sinusoidal signal that includes the resonant frequency. Filter circuit 220 can be omitted if driver circuit 210 can generate driver signals 216a and 216b as sinusoidal signals (e.g., in a limited bandwidth). In some examples, driver circuit 210 may include analog circuitry (such as a current source, a current mirror, a voltage source, a phase shifter, and/or an amplifier (e.g., a class-D amplifier)) and/or digital circuitry.

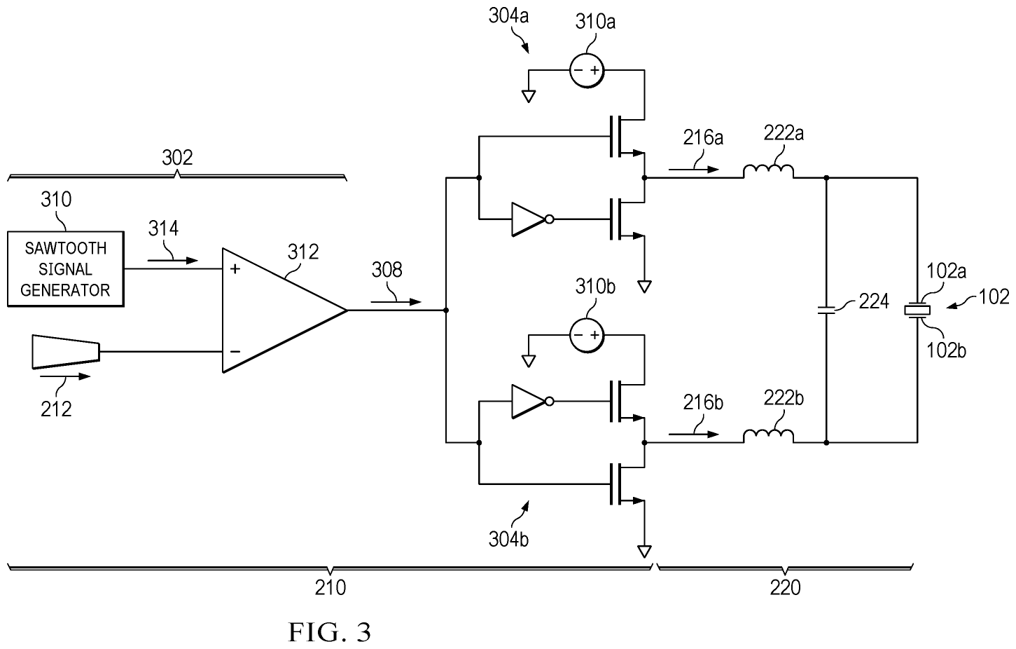

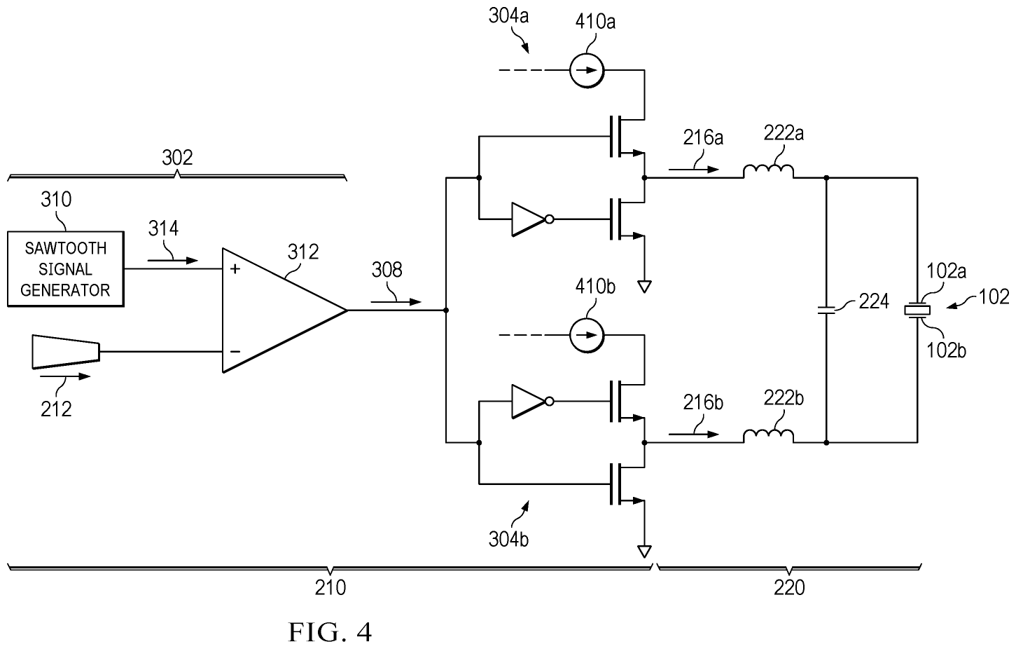

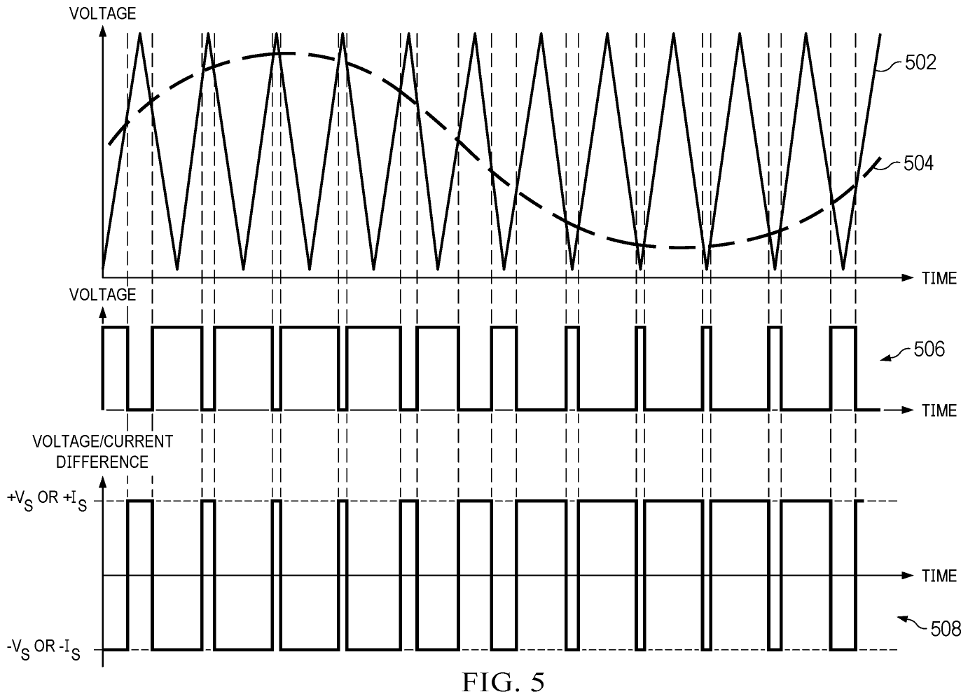

FIGS. 3 and 4 are schematics of examples of driver circuit 210. In FIGS. 3 and 4, sense circuit 202 is omitted for brevity. Referring to FIGS. 3 and 4, driver circuit 210 can include a pulse width modulation (PWM) signal generator 302 and a pair of switching amplifiers 304a and 304b. PWM signal generator 302 generates a PWM signal 308 having a duty cycle (or pulse width) that tracks control signal 212 (e.g., the duty cycle/pulse width of signal 308 tracks the magnitude of signal 212). In some examples, PWM signal generator 302 can include a sawtooth signal generator 310 and a comparator 312. Also, switching amplifiers 304a and 304b can be part of respective signal sources 211a and 211b. In the example of FIG. 3, switching amplifiers 304a and 304b can be coupled to respective voltage sources 310a and 310b to provide a voltage mode driver circuit. Also, in the example of FIG. 4, switching amplifiers 304a and 304b can be coupled to respective current sources 410a and 410b to provide a current mode driver circuit. Operation of the circuitry of FIGS. 3 and 4 are described in more detail below with reference to FIG. 5.

FIG. 5 are waveform diagrams that illustrate example operations of driver circuit 210 of FIGS. 3 and 4. FIG. 5 includes graphs 502, 504, 506, and 508. Graph 502 can represent the variation of sawtooth signal 314 with time, graph 504 can represent the variation of control signal 212 with time, graph 506 can represent the variation of PWM signal 308 with time, and graph 508 can represent the variation of a voltage/current difference between the outputs of switching amplifiers 304a and 304b.

Referring to FIG. 5, sawtooth signal generator 310 can generate a sawtooth signal 314 having a higher frequency than control signal 212, which can be a sinusoidal signal having the same frequency as driver signals 216a and 216b. Comparator 312 can generate PWM signal 308 by comparing control signal 212 with sawtooth signal 314. PWM signal 308 can be in a first state (e.g., an asserted state, a “high” state, etc.) when the voltage of sawtooth signal 314 exceeds the voltage of control signal 212, and can be in a second state (e.g., a de-asserted state, a “low state”, etc.) when the voltage of sawtooth signal 314 is below the voltage of control signal 212.

Responsive to PWM signal 308 being in a first state (e.g., in an asserted state), switching amplifier 304a can connect voltage source 310a (which my supply a voltage Vs) or current source 410a (which may supply a current Is) to inductor 222a to provide a voltage signal Vs or a current signal Is as driver signal 216a. Also, switching amplifier 304b can connect inductor 222b to a common potential (e.g., ground) responsive to PWM signal 308 being in the first state. As a result of this, switching amplifier 304b provides a zero/inactive driver signal 216b. Responsive to PWM signal 308 being in the second state, switching amplifier 304b can connect voltage source 310b or current source 410b to inductor 222b to provide voltage signal Vs or current signal Is as driver signal 216b. Also, switching amplifier 304a can connect inductor 222a to ground and provide a zero/inactive driver signal 216a.

Accordingly, referring to graph 508 of FIG. 5, in the durations when PWM signal 308 is in the first state, the voltage/current difference between the outputs of switching amplifiers 304a and 304b can be equal to respective positive Vs or positive Is, where the positive Is represents that the current flows out of switching amplifier 304a and into switching amplifier 304b. Also, in the durations when PWM signal 308 is in the second state, the voltage/current difference between the outputs of switching amplifiers 304a and 304b can be equal to respective negative Vs or negative Is, where the negative Is represents that the current flows out of switching amplifier 304b and into switching amplifier 304a. Filter circuit 220 can perform low pass filtering operations on the voltage/current signals of driver signals 216a and 216b to remove high frequency components. The filtered driver signals can be a sinusoidal signal having the same frequency as control signal 212, and can cause transducer 102 to vibrate/oscillate at that frequency. In some examples, signal 508 may be a differential voltage that is applied across terminals 102a and 102b of transducer 102. In other examples, signal 508 may be the current through transducer 102 and may be the sum of signals 216a and 216b (for the examples where these signals 216a and 216b represent currents).

Referring again to FIG. 2, in addition to switching amplifiers, driver circuit 210 can include linear amplifiers that can receive a sinusoidal control signal 212 and provide driver signals 216a and 216b as sinusoidal signals, and filter circuit 220 can be omitted. For example, each of signal sources 211a and 211b can include a linear amplifier, such as a class A amplifier, a class B amplifier, or a class AB amplifier, that can provide driver signals 216a and 216b by amplifying control signal 212.

As described above, driver circuit 210 can drive transducer 102 at the resonant frequency of transducer 102 to maximize the amount of power transferred to transducer 102, and to improve the efficiency of lens cleaning system 200 in removing objects from outer lens surface 107a. The resonant frequency can be a frequency at which transducer 102 has a minimum impedance.

In some examples, controller 204 can access an impedance profile 240 from a memory 250 of lens cleaning system control circuit 130, and determine the resonant frequency of transducer 102 from impedance profile 240. Impedance profile 240 can map between the impedances and oscillation frequencies of transducer 102. From impedance profile 240, lens cleaning module 206 can determine, within an operation frequency range, an oscillation frequency at which transducer 102 has a minimum impedance as the resonant frequency. The operation frequency range can be based on various factors, such as a shape of lens 104, a direction of vibration motion of lens 104, electromechanical properties of the transducer 102, a shape of the transducer 102, a plating direction of the transducer 102, frequency response of filter circuit 220, and a maximum oscillation amplitude at a particular frequency without damaging lens 104.

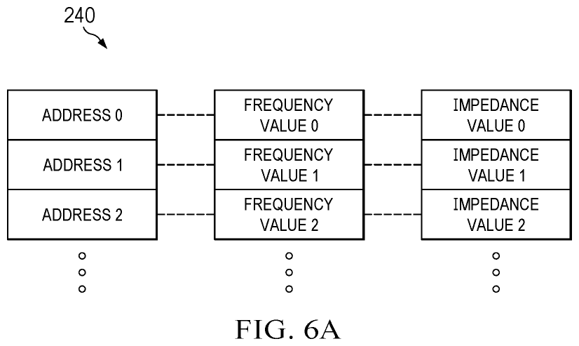

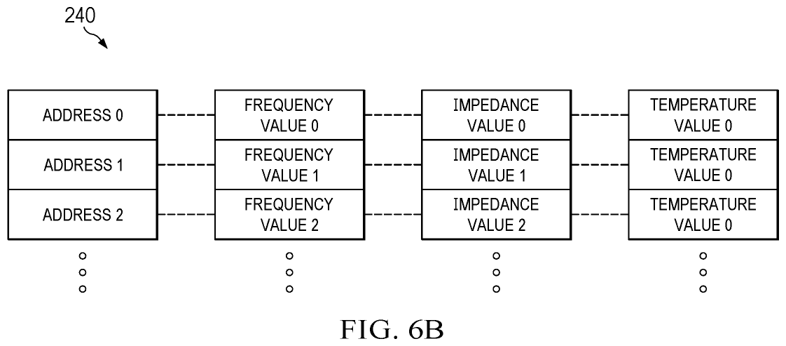

FIG. 6A and FIG. 6B are schematics of example impedance profiles 240. Referring to FIGS. 6A and 6B, impedance profile 240 can be in the form of a mapping table and can include different memory addresses of memory 250 mapped to frequency values and to impedance values. For example, in FIG. 6A, address 0 of memory 250 can be mapped to frequency value 0 and to impedance value 0, address 1 of memory 250 can be mapped to frequency value 1 and to impedance value 1, and address 2 of memory 250 can be mapped to frequency value 2 and to impedance value 2. Each memory address in impedance profile 240 can reference an N-bit memory space, where the frequency value can be stored in the first subset of the memory bits (e.g., bits 0 to x−1) and the impedance value can be stored in the second subset of the memory bits (e.g., bits x to N−1). Impedance profile 240 may map the frequency values to additional operation metrics, such as operation temperatures of transducer 102 (or lens cleaning systems 200). For example, in FIG. 6B, each memory address can be mapped to a frequency value, an impedance value, and a temperature value representing the operation temperature of transducer 102 having an oscillation frequency equal to the frequency value. In such examples, at each memory space referenced in impedance profile 240 can have M bits, the frequency value can be stored in a first subset of the memory bits (e.g., bits 0 to x−1), the impedance value can be stored in a second subset of the memory bits (e.g., bits x to N−1), and the impedance value can be stored in a third subset of the memory bits (e.g., bits N to M−1). In some examples, these values may be stored in memory 250 during fabrication of the device, during testing of the device, during system test (where the device is implemented into a system), during start-up of the system and/or during operation of the system.

In some examples, controller 204 can obtain other information from impedance profile 240 based on the mapping between the memory addresses, the oscillation frequencies, and operation metrics, such as impedance and temperature. For example, controller 204 can traverse the memory addresses listed in impedance profile 240, extract the frequency value and the impedance value in a memory space referenced by each memory address, select oscillation frequencies within an operation frequency range and impedance values mapped to the selected frequencies, identify a minimum impedance value among the impedance values, and identify the oscillation frequency mapped to the minimum impedance value as the resonant frequency. As another example, controller 204 can identify an impedance value and/or a temperature value mapped to a particular oscillation frequency from impedance profile 240.

In some examples, controller 204 can include an impedance profile determination module 232 to perform a calibration operation using sensor circuit 202 to generate impedance profile 240. Specifically, sensor circuit 202 can include a current sense resistor 234 coupled between driver circuit 210 and one of electrodes 102a or 102b to measure a current that flows through transducer 102. Sensor circuit 202 can also measure a voltage between electrodes 102a and 102b. Sensor circuit 202 can also include a current measurement circuit 236 and a voltage measurement circuit 238, each can include an analog-to-digital converter (ADC), to convert the measured current and voltage to digital signals.

As part of the calibration operation, impedance profile determination module 232 can access a frequency list and cause driver control module 208 to provide control signal 212 at each frequency on the frequency list, so that driver circuit 210 can drive transducer 102 at those frequencies. Impedance profile determination module 232 can cause driver control module 208 to provide control signal 212 having a single frequency, or provide multiple control signals 212 having multiple frequencies. When transducer 102 vibrates responsive to driver signals 216a/216b, sensor circuit 202 can generate measurements of the voltage across and current through transducer 102. Sensor circuit 202 can then provide the voltage and current measurements as sense signals 230 back to controller 204. Impedance profile determination module 232 can extract the voltage and current measurements at a particular oscillation frequency, and determine an impedance of transducer 102 based on a ratio between the voltage and current measurements.

Impedance profile determination module 232 can generate an impedance profile 240 based on a frequency domain computation. With frequency domain computation, impedance profile determination module 232 can cause driver control module 208 to provide control signal 212 having multiple frequencies, and obtain the voltage and current measurements of transducer 102 vibrating/oscillating in response to the driver signals 216a/216b having the multiple frequencies. Impedance profile determination module 232 can perform domain transformation operations, such as Fourier transform operations, on the voltage and current measurements to transform the measurements from time domain representations to frequency domain representations, and compute the impedance values in the frequency domain based on a ratio between the transformed voltage and current measurements. Examples of Fourier transform operations, and related operations, can include Discrete Fourier Transform (DFT), Fast Fourier Transform (FFT), Hilbert Transform, and Z Transform. For example, an impedance value at a particular frequency can be based on a ratio between the DFT coefficient of the voltage measurements and the DFT coefficient of the current measurements at that frequency. Impedance profile determination module 232 can then generate impedance profile 240 by mapping the impedance values in the frequency domain to the frequencies in the frequency list.

After generating impedance profile 240, impedance profile determination module 232 can store impedance profile 240 at memory 250. Lens cleaning module 206 can fetch impedance profile 240 from memory 250 and determine the resonant frequency based on the mappings between the impedance values and the frequency values as described above. In some examples, impedance profile 240 can be distributed to other lens cleaning system as a nominal impedance profile. Each system can use the nominal impedance profile to determine the resonant frequency for the lens cleaning operation and other operations.

In some examples, controller 204 can also include a temperature detection module 251, an object detection module 252, and/or a fault detection module 254. Some or all of these modules can also operate based on impedance profile 240. Specifically, temperature detection module 251 can obtain the temperature of transducer 102 at a particular oscillation frequency based on mapping between temperatures and the oscillation frequencies from impedance profile 240 (e.g., of FIG. 6B), and compare the temperature with a threshold, which can be based on a Curie temperature of transducer 102. Controller 204 can set control signal 212 in an inactive state to stop the vibration of transducer 102 (and lens 104) if the temperature is above the threshold to avoid overheating lens 104 and/or depolarizing the piezoelectric material of transducer 102.

Also, object detection module 252 can detect the presence of an object (e.g., water and dust) on outer lens surface 107a by monitoring a change in the resonant frequency of transducer 102. The presence of the object can add mass to lens 104, which changes the natural frequency of vibration of lens 104. The resonant frequency of transducer 102 can also change with the natural frequency. In some examples, to support the object detection operation, impedance profile determination module 232 can generate updated impedance profiles 240. Between the updated impedance profiles, object detection module 252 can detect a shift in the resonant frequency of transducer 102, and if the resonant frequency shift exceeds a threshold, object detection module 252 can determine that an object is present on outer lens surface 107a. In some examples, responsive to determining that that an object is present on outer lens surface 107a, object detection module 252 can start a lens cleaning operation to drive transducer 102 at the shifted resonant frequency from the updated impedance profile to remove the object from outer lens surface 107a. Object detection module 252 can also cause driver control signal generation module 204 to stop/suspend the lens cleaning operation if the change in the resonant frequency is below the threshold, which can indicate that the object has been removed (or no object is detected). Such arrangements can reduce the overall amount of power provided to transducer 102 and further improve the efficiency of the lens cleaning operation.

Also, fault detection module 254 can detect a fault condition in lens assembly 100 based by monitoring a change in the impedance of transducer 102 at a particular frequency, such as at the resonant frequency. Examples of fault condition may include depolarization of the piezoelectric material of transducer 102; physical damage (e.g., cracking) in transducer 102 and/or lens 104; and/or failure in other components of lens assembly 100, such as ring 112 and a glue layer between transducer 102 and lens 104. In some examples, fault detection module 254 can cause driver control signal generation module 204 to drive transducer 102 at the resonant frequency, receive sense signals 230 (including the voltage and current measurements), and compute an impedance of transducer 102 at the resonant frequency. Fault detection module 254 can compare the impedance with a target impedance mapped to the resonant frequency in impedance profile 240 to generate an impedance difference. If the impedance difference exceeds a threshold, fault detection module 254 can determine that a fault condition is detected, and may suspend or disable the lens cleaning operation.

Controller 204 can trigger lens cleaning module 206, impedance profile determination module 232, temperature detection module 251, object detection module 252, and fault detection module 254 to perform the respective operations based on various conditions. For example, controller 204 can receive an external signal (e.g., from an input interface coupled to camera lens assembly 100) and trigger one of the modules responsive to the signal. As another example, controller 204 can trigger each module based on predetermined schedules. For example, controller 204 can include a timer for each of trigger lens cleaning module 206, impedance profile determination module 232, temperature detection module 251, object detection module 252, and fault detection module 254, and can trigger a module responsive to expiration of the timer for that module. Also, some of the modules can trigger another module. For example, object detection module 252 can trigger impedance profile determination module 232 to generate an updated impedance profile to determine resonant frequency shift, and trigger lens cleaning module 206 to start a lens cleaning operation responsive to the resonant frequency shift indicating that an object is detected on outer lens surface 107a, as described above.

Although impedance profile 240 can provide resonant frequency and impedance information to support the lens cleaning and various detection operations (e.g., object detection, temperature detection, and fault detection), various issues can affect the accuracy of the information, which can degrade the lens cleaning and detection operations that use the information.

Specifically, in examples of lens cleaning systems 200 where driver circuit 210 is a voltage mode driver (e.g., the example of FIG. 3) and provides driver signals 216a and 216b as a voltage signal, filter circuit 220 together with transducer 102 can be a combined load to driver circuit 210, because the resulting current signal is divided between filter circuit 220 and transducer 102 according to their respective impedances. The amount of power transferred by driver circuit 210 to the combined load can be maximized (for a particular signal level of driver signals 216a/216b) if the impedance of the combined load is at a minimum, which can occur if driver signals 216a/216b are at the resonant frequency of the combined load, and the current that flows through the combined load can also be at a maximum. But, because the combined impedance of filter circuit 220 and transducer 102 are different than the impedance of transducer 102, the resonant frequency of transducer 102 may not be the same as the resonant frequency of the combined load of filter circuit 220 and transducer 102. Accordingly, the current that flows through transducer 102 (and the amount of power delivered to transducer 102) may not be at a maximum when transducer 102 is driven at the resonant frequency of transducer 102.

On the other hand, in examples of lens cleaning systems 200 where driver circuit 210 is a current mode driver (e.g., the example of FIG. 4) that provides a preconfigured current signal to both transducer 102 and filter circuit 220, and in examples of lens cleaning systems 200 where filter circuit 220 is omitted because driver circuit 210 includes a linear amplifier to provide sinusoidal driver signals 216a/216b, the amount of current that flows through transducer 102 is not affected by the impedance of filter circuit 220. Accordingly, the amount of power transferred by driver circuit 210 to transducer 102 can still be maximized (for a particular current level of driver signals 216a/216b) by driving transducer 102 at the resonant frequency of transducer 102.

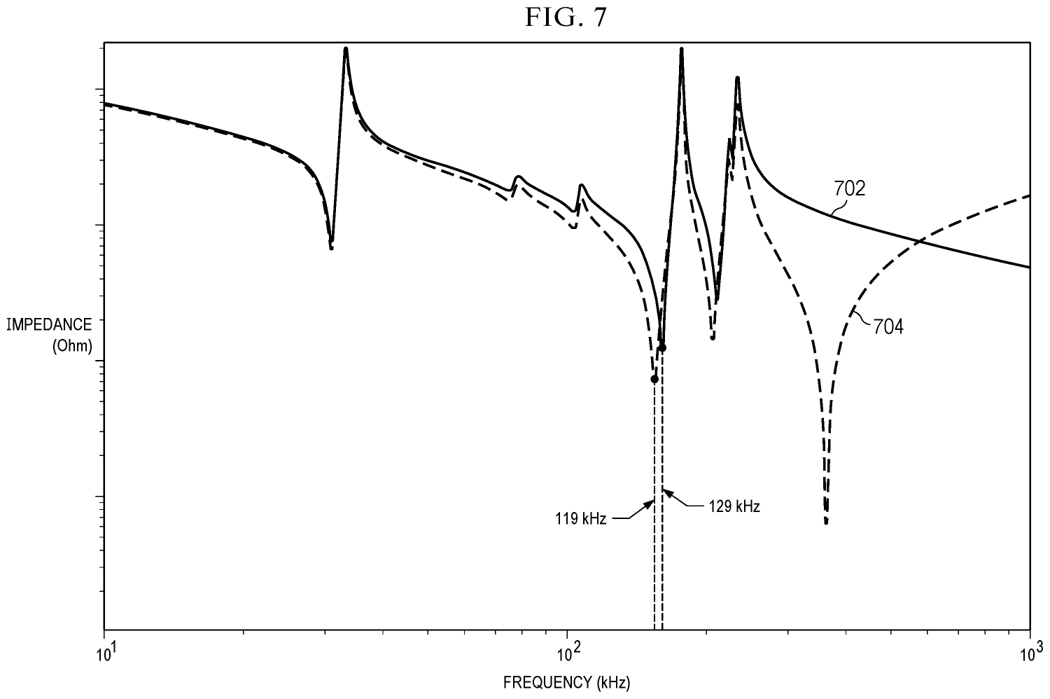

FIG. 7 includes waveform graphs 702 and 704 of example variations of impedance with frequency. Graph 702 illustrates an example variation of impedance of transducer 102 with the oscillation frequency of transducer 102, and graph 704 illustrates an example variation of the combined impedance of filter circuit 220 and transducer 102 with the oscillation frequency of transducer 102, within a frequency range of 10 to 1000 kilohertz (kHz). In FIG. 7, the impedances are in a logarithmic scale. In FIG. 7 and the rest of figures, the numerical values are provided as non-limiting examples to illustrate the operations of example lens cleaning system.

Referring to FIG. 7, transducer 102 can have a resonant frequency at 129 kHz where the impedance of transducer 102 is at a minimum within an operation frequency range of 110 to 130 kHz. Also, a combined load of filter circuit 220 and transducer 102 can have a resonant frequency at 119 kHz, where the impedance of the combined load is at a minimum. Accordingly, there is a shift of 10 kHz between the two resonant frequencies. The resonant frequency shift can increase with the amount of power delivered to the combined load. Because of the resonant frequency shift, if driver circuit 210 drives the combined load at the resonant frequency of transducer 102, driver circuit 210 may transfer a reduced amount of power to transducer 102 compared to driving the combined load at the resonant frequency of the combined load, where the impedance of the combined load is at a minimum.

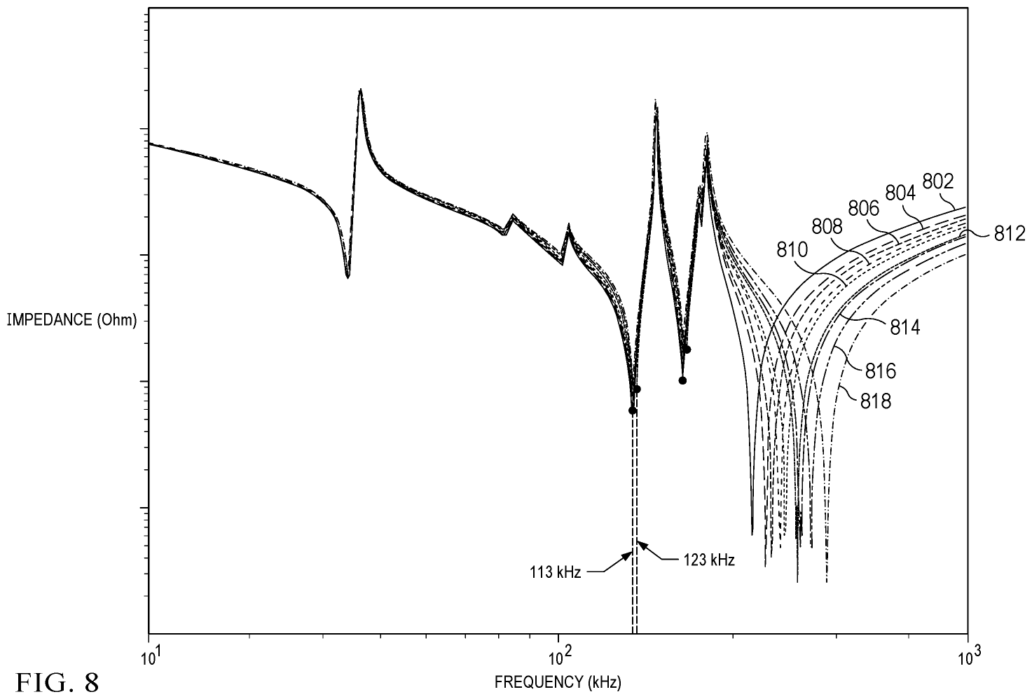

The resonant frequency shift can be further exacerbated by variations in the impedances of components of lens cleaning system 200, such as transducer 102, inductors 222a/222b, and capacitor 224 of filter circuit 220. There can be various sources for the impedance variations, such as limited precision in the manufacturing processes and aging. FIG. 8 includes waveform graphs 802-818 of combined impedance profiles of filter circuit 220 and transducer 102 within a 20% range of variation. In FIG. 8, the impedances are in a logarithmic scale. Referring to FIG. 8, the resonant frequency from graph 802 is 113 kHz, and the resonant frequency from graph 718 is 123 kHz, which represents a range of frequency variation of 10 kHz around a nominal combined load resonant frequency of 119 kHz (from FIG. 7), which can add to the resonant frequency shift. Accordingly, if impedance profile 240 does not account for the resonant frequency difference between transducer 102 and the combined load of transducer 102 and filter circuit 220 as well as the impedance variations of transducer 102 and filter circuit 220, the impedance values stored in impedance profile 240 may be inaccurate, and the amount of power transferred to transducer 102 can be reduced if driver circuit 210 drives transducer 102 at an inaccurate resonant frequency obtained from impedance profile 240.

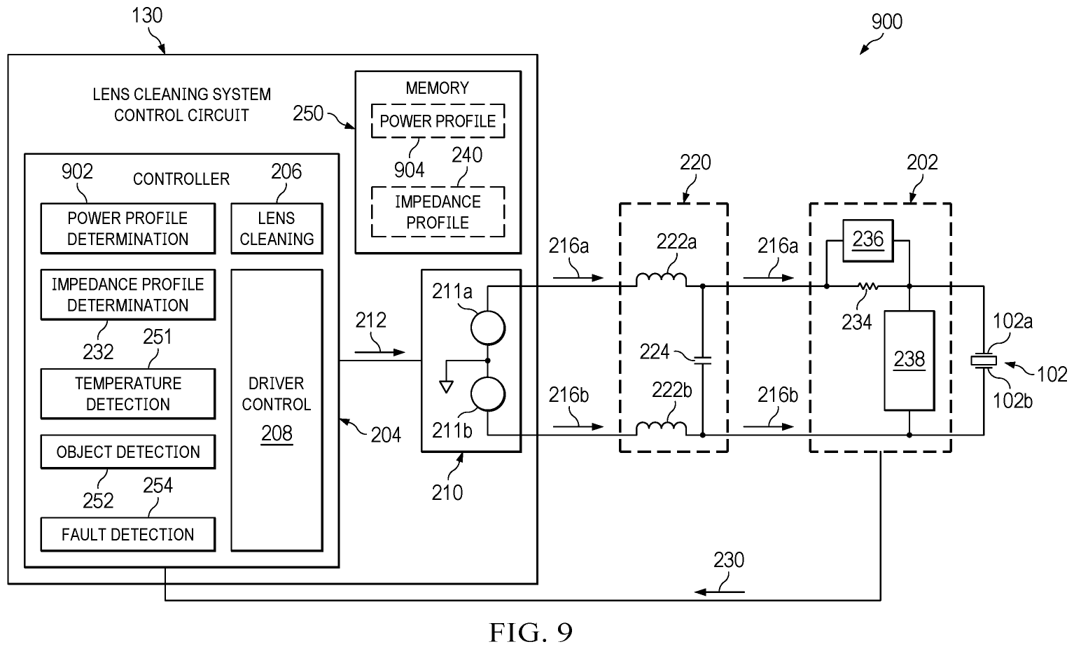

FIG. 9 is schematic diagram of an example lens cleaning system 900 that can address at least some of the issues described above. Referring to FIG. 9, controller 204 can include a power profile determination module 902, which can generate a power profile 904 of transducer 102 and store power profile 904 in memory 250. Power profile 904 can include a mapping between power metrics and oscillation frequencies of transducer 102, in which each power metric is indicative of an amount of power transferred to transducer 102 when transducer 102 oscillates/vibrates at a frequency mapped to the power metric. As to be described below, power profile determination module 902 can perform a calibration operation by accessing a frequency list, and measure the power metrics at each frequency of the frequency list. In some examples, Controller 204 can trigger power profile determination module 902 to generate power profile 904 responsive to an external signal or as part of a periodic calibration operation.

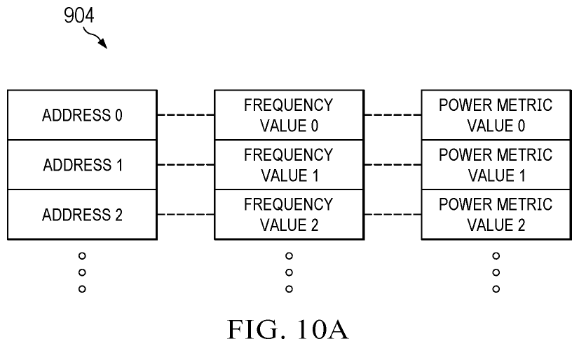

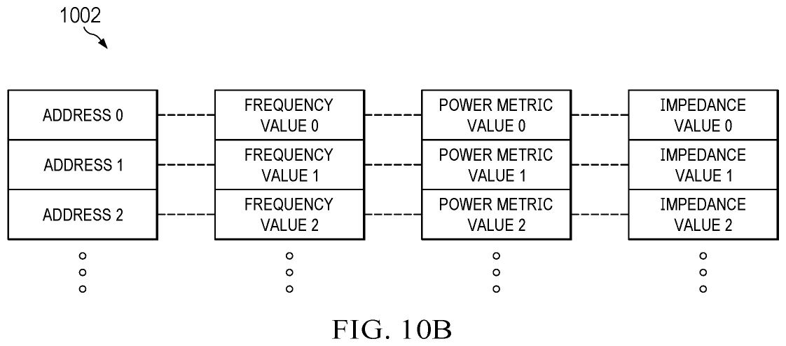

FIG. 10A is a schematic of an example power profile 904. Referring to FIG. 10A, power profile 904 can also be in the form of a mapping table and can include different memory addresses of memory 250 mapped to frequency values and to power metric values. As to be described below, a power metric value can include a power value representing an amount of power provided to/rejected by transducer 102, a current value representing a current through transducer 102, or a voltage value representing a voltage across transducer 102. Each memory address in power profile 904 can reference an N-bit memory space, where the frequency value can be stored in the first subset of the memory bits (e.g., bits 0 to x−1) and the power metric value can be stored in the second subset of the memory bits (e.g., bits x to N−1). In some examples, the power metric values may be stored in memory 250 during fabrication of the device, during testing of the device, during system test (where the device is implemented into a system), during start-up of the system and/or during operation of the system.

Referring again to FIG. 9, lens cleaning module 206 can traverse the memory addresses listed in power profile 904 to select oscillation frequencies within an operation frequency range and power metric values mapped to the selected frequencies, identify a power metric value indicating a maximum amount of power delivered to transducer 102, and identify the oscillation frequency mapped to the identified power metric value as a resonant frequency of transducer 102 or of the combined load of transducer 102 and filter circuit 220. Lens cleaning module 206 can then cause driver control module 208 and driver circuit 210 to drive transducer 102 at the identified resonant frequency. Further, in some examples, object detection module 252 can also trigger power profile determination module 902 to generate an updated power profile 904. Between the updated power profiles, object detection module 252 can detect a resonant frequency shift, and determine whether an object is detected on outer lens surface 107a if the resonant frequency shift exceeds a threshold, as described above, and lens cleaning module 206 can cause driver control module 208 and driver circuit 210 to drive transducer 102 at the shifted resonant frequency from the updated power profile 904.

Because transducer 102 and filter circuit 220 share the same current, at the oscillation frequency where transducer 102 receives and consumes a maximum amount of power, the combined load of transducer 102 and filter circuit 220 can also receive a maximum amount of power, and that oscillation frequency can represent the resonant frequency of the combined load where the impedance of the combined load is at a minimum. Accordingly, driving transducer 102 at such a resonant frequency can ensure maximum power transfer to transducer 102, and the power efficiency and the cleaning performance of lens cleaning system 800 can also improve. As to be described below, power profile determination module 902 can determine power profile 904 based on a voltage measurement, a current measurement, or both, from sense signals 230 of sensor circuit 202.

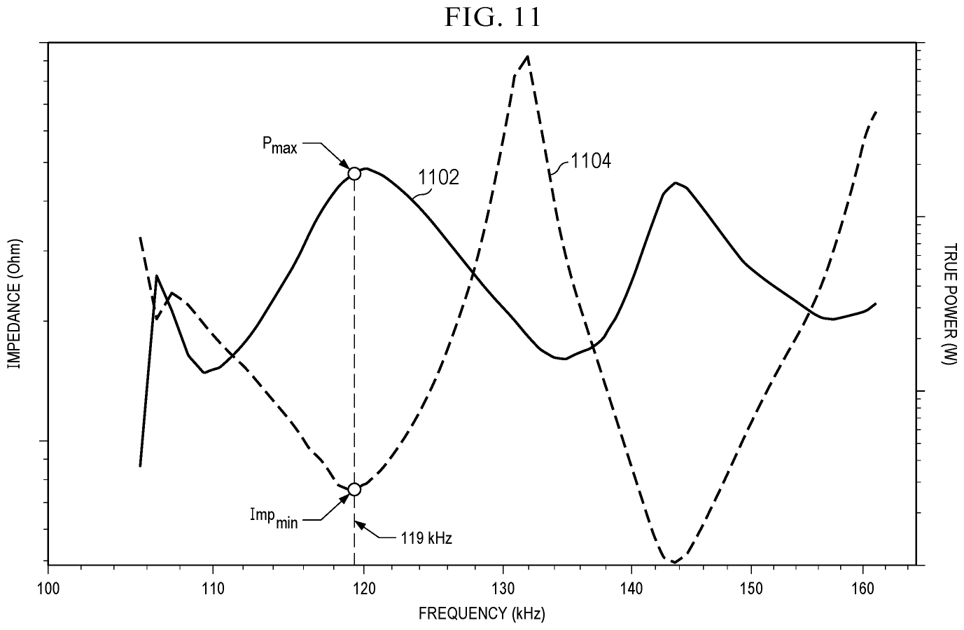

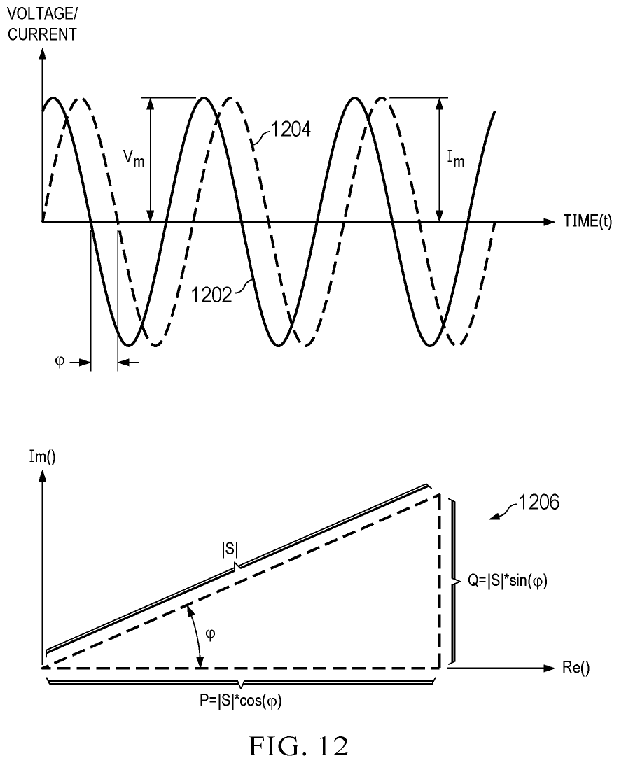

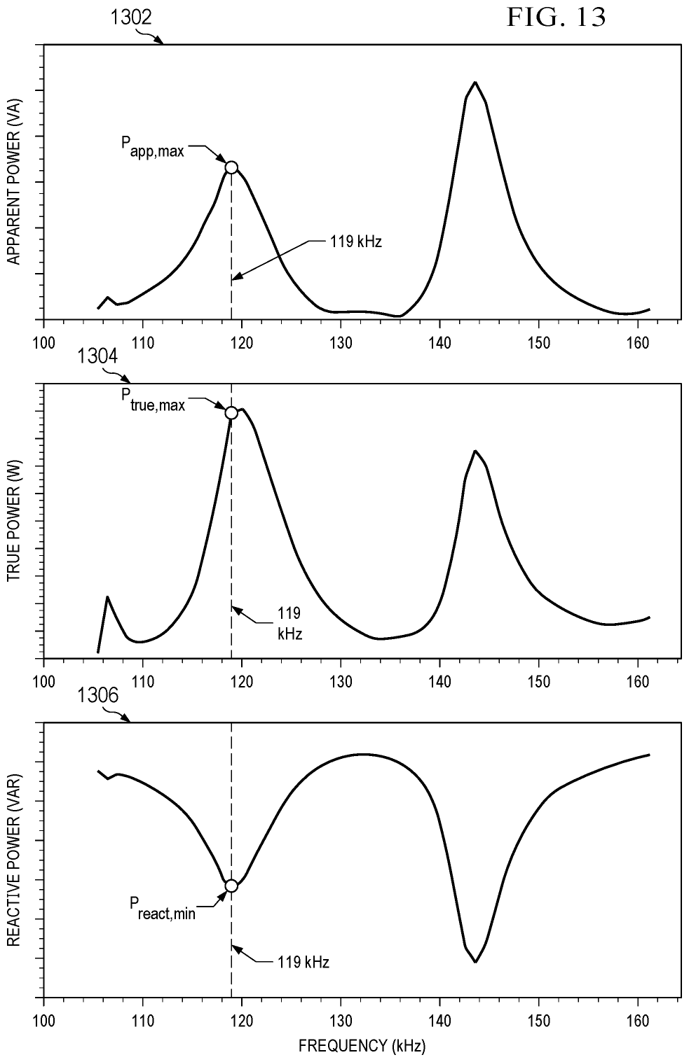

FIG. 11 includes waveform graphs that compare variations of a power metric in an example power profile 904 and variations of impedance of the combined load of transducer 102 and filter circuit 220 in an example impedance response. Graph 1102 illustrates a variation of true power consumed by transducer 102 with oscillation frequency represented by power profile 904, and graph 1104 illustrates the variation of impedance of the combined load of transducer 102 and filter circuit 220 versus oscillation frequency. In FIG. 11, the power metric and impedance are in a logarithmic scale. Within an operation frequency range of 110 to 130 kHz (which can be based on the mechanical property of lens 104) and for a particular signal level of driver signals 216a/216b, a maximum amount of power can be transferred to transducer 102 (labelled Pₘₐₓ in FIG. 11) at a driving frequency of 119 kHz, which is also the frequency of minimum impedance of the combined load (labelled Impₘᵢₙ in FIG. 11). Accordingly, driving transducer 102 at the frequency of 119 kHz as indicated by power profile 904 can maximize power transfer to transducer 102.

Referring again to FIG. 9, memory 250 of lens cleaning system 900 can also store impedance profile 240 in addition to power profile 904, where lens cleaning system 900 may access one of the two profiles for different operations. For example, as described above, lens cleaning module 206 and object detection module 252 can operate based on power profile 904. In some examples, object detection module 252 can also operate based on impedance profile 240. Also, temperature detection module 251 and fault detection module 254 operate based on information about the impedance of transducer 102, and may access impedance profile 240 for the temperature detection and fault detection operations. In some examples, memory 250 can store a combined profile 1002 of power metric values and impedance values. FIG. 10B is a schematic of an example combined profile 1002. Referring to FIG. 10B, the combined profile can also be in the form of a mapping table and can include different memory addresses of memory 250 mapped to frequency values, power metric values, and impedance values. Each memory space referenced in profile 1002 can have M bits, the frequency value can be stored in a first subset of the memory bits (e.g., bits 0 to x−1), the impedance value can be stored in a second subset of the memory bits (e.g., bits x to N−1), and the impedance value can be stored in a third subset of the memory bits (e.g., bits N to M−1).

Both power profile determination module 902 and impedance profile determination module 232 can perform periodic calibration operations (e.g., once every year) to update respective power profile 904 and impedance profile 240 based on sense signals 230 of sensor circuit 202 periodically. Such arrangements allow power profile 904 and impedance profile 240 to account for changes in the power profile and impedance profile due to, for example, component variations and aging.

As described above, power profile 904 can include various power metrics that are indicative of an amount of power delivered to transducer 102 at different oscillation frequencies. For example, power profile 904 can include power values indicating an amount of power delivered to transducer 102 at different driving frequencies, which power profile determination module 902 can compute based on the current and voltage measurements from sensor circuit 202. The power values can represent the apparent power magnitude value (|S|), the reactive power value (Q), and/or the true power value (P). The apparent power magnitude value (|S|) can be the amount of power provided by driver circuit 210, the true power value (P) can be the amount of power received and consumed by transducer 102, and the reactive power value (Q) can be the amount of power reflected/rejected by (and therefore not delivered to) transducer 102. To increase the amount of power delivered to transducer 102, both apparent power and true power can be increased, while the reactive power can be decreased.

FIG. 12 includes waveform graphs 1202 and 1204 that illustrate respective voltage and current signals of transducer 102 responsive to sinusoidal driver signals 216a/216b, and a graph 1206 that illustrates the relationships between apparent power magnitude value (|S|), the reactive power value (Q), and/or the true power value (P) of transducer 102 corresponding to graphs 1202 and 1204. Referring to graphs 1202 and 1204, both voltage and current signals can be sinusoidal, with the voltage signal having an amplitude of Vₘ and the current signal having an amplitude of Iₘ. The current signal can also lag behind the voltage signal by a phase angle of φ. Referring to graph 1206, power profile determination module 902 can compute an apparent power magnitude value (|S|), a true power value (P), and a reactive power value (Q) based on these Equations:

|S|=Vₘ×Iₘ (Equation 1)

P=Vₘ×Iₘ×cos(φ)=|S|cos(φ) (Equation 2)

Q=Vₘ×Iₘ×sin(φ)=|S|sin(φ) (Equation 3)

FIG. 13 includes waveform graphs that illustrate example variations of apparent power, true power, and reactive power values of transducer 102 with respect to oscillation frequency of transducer 102, each of which can be represented in power profile 904. In FIG. 13, graph 1302 illustrates example variations of apparent power with frequency, graph 1304 illustrates example variations of true power with frequency, and graph 1306 illustrates example variation of reactive power with power. Referring to FIG. 13, within an operation frequency range of 110 to 130 kHz and for a particular signal level of driver signals 216a/216b, maximum apparent power (labelled P_{app,max} in FIG. 13), maximum true power (labelled P_{true,max} in FIG. 13), and minimum reactive power (labelled P_{react,max} in FIG. 13) of transducer 102 occur at the oscillation frequency of 119 kHz. Accordingly, driver circuit 210 can deliver a maximum amount of power to transducer 102 at a driving frequency of 119 kHz, which can be the resonant frequency of the combined load of filter circuit 220 and transducer 102. In a case where filter circuit 220 is omitted or where driver circuit 210 is a current mode driver, peak apparent power and true power, and minimum reactive power, can also occur at the resonant frequency of transducer 102 where the impedance of transducer 102 is at a minimum. Accordingly, lens cleaning module 206 and object detection module 252 can identify the resonant frequency to maximize the power transfer to transducer 102 by identifying the frequency of peak apparent power, peak true power, or minimum reactive power from power profile 904.

In addition to power values, power profile 904 can include other metrics that are indicative of an amount of power delivered to transducer 102 at different driving frequencies. For example, in a case where driver circuit 210 is a voltage mode driver and provides driver signals 216a/216b as a voltage signal having a particular voltage level, the current that flows across transducer 102 can vary with the driver signal frequency, and power profile 904 can represent the variation of a current that flows through transducer 102 with respect to oscillation frequency. The current (I) can be related to the true power value (P) of transducer 102 based on the following Equation:

P=I²×R (Equation 4)

In Equation 4, R represents the resistance of transducer 102. Since the delivered power increases with the current, the resonant frequency for maximum power transfer to the combined load can be equal to the oscillation frequency of peak current through transducer 102.

Also, in a case where driver circuit 210 is a current mode driver and provides driver signals 216a/216b as a current signal having a particular current level, the voltage across transducer 102 can also vary with the driver signal frequency, and power profile 904 can represent the variation of a voltage across transducer 102 with respect to oscillation frequency. The voltage (V) across transducer 102 can be related to the true power value (P) of transducer 102 based on the following Equation:

$$P = \frac{{V}^{2}}{R} \qquad ( Equation 5 )$$

From Equation 5, the delivered power increases with the voltage. Accordingly, the resonant frequency for maximum power transfer to the combined load can also be equal to the oscillation frequency of peak voltage across transducer 102.

FIG. 14 includes waveform graphs that illustrate example variations of current and voltage across transducer 102 with respect to the oscillation frequency of transducer 102, each of which can be represented in power profile 904. In FIG. 14, graph 1402 illustrates example variation of an RMS current through transducer 102 and graph 1404 illustrates example variation of an RMS voltage across transducer 102 in a case where driver circuit 210 is a voltage mode driver. Referring to graphs 1402 and 1404, within the operation frequency range of 110 to 130 kHz, peak RMS voltage (labelled Vₘₐₓ in FIG. 14) and peak RMS current (labelled Iₘₐₓ in FIG. 14) occur at the oscillation frequency of 1119 kHz. Accordingly, driver circuit 210 can deliver a maximum amount of power to transducer 102 at a driving frequency of 119 kHz, which can be the resonant frequency of the combined load of filter circuit 220 and transducer 102. Lens cleaning module 206 and object detection module 252 can also identify the resonant frequency to maximize the power transfer to transducer 102 by identifying the frequency of peak voltage or peak current from power profile 904.

Power profile determination module 902 can generate the various metrics of power profile 904 based on time domain or frequency domain computations. With time domain computation, impedance profile determination module 232 can cause driver control module 208 to provide control signal 212 having a single frequency at a time, and obtain the current and/or voltage measurements of transducer 102 when the transducer vibrates/oscillates at that frequency. For power profiles based only on current or voltage values (e.g., graphs 1202 and 1204 of FIG. 12), power profile determination module 902 can compute a current value or a voltage value that reflects a respective amplitude of the current or voltage signal from the current or voltage measurements (e.g., RMS of the measurements) at a particular oscillation/driving frequency of transducer 102, and map the current/voltage value to that frequency. Power profile determination module 902 can repeat the driving of transducer 102 and measurements of current/or voltage across the transducer at different frequencies according to a frequency list, and generate the power profile that maps the voltage/current values to the different frequencies of the frequency list.

Also, power profile determination module 902 can compute the apparent power magnitude value (|S|), true power value (P), and/or reactive power value (Q) based on current and voltage measurements for a particular oscillation frequency. For example, power profile determination module 902 can compute the apparent power magnitude value (|S|) based on computing the root mean square of N samples of current (I) and voltage (V) measurements as follows:

$${I}_{RMS} = \sqrt{\frac{1}{N} {\sum }_{n = 1}^{N} {( I [ n ] )}^{2}} \qquad ( Equation 6 )$$

$${V}_{RMS} = \sqrt{\frac{1}{N} {\sum }_{n = 1}^{N} {( V [ n ] )}^{2}} \qquad ( Equation 7 )$$

$$\vert S \vert = {I}_{RMS} \times {V}_{RMS} \qquad ( Equation 8 )$$

Also, power profile determination module 902 can compute the true power value (P) based on computing a mean of products between corresponding current and voltage samples, which represents an instantaneous power, as follows:

P=Σₙ₌₁^{N}(V[n]×I[n]) (Equation 9)

Further, power profile determination module 902 can compute the reactive power value (Q) by computing the phase angle φ based on a ratio between the true power (from Equation 9) and the magnitude of the apparent power (from Equation 8) as follows:

$$φ = {cos}^{- 1} ( \frac{P}{\vert S \vert} ) \qquad ( Equation 10 )$$

$$Q = \vert S \vert \times sin ( φ ) \qquad ( Equation 11 )$$

Power profile determination module 902 can repeat the driving of transducer 102 and measurements of current and voltage across the transducer at different frequencies according to a frequency list, compute the apparent power, true power, and/or reactive power values for different frequencies on the frequency list based on Equations 6 to 11, and map the power values to the different frequencies.

Also, with frequency domain computation, power profile determination module 902 can cause driver control module 208 to provide control signal 212 having multiple frequencies, and obtain the current and/or voltage measurements of transducer 102 vibrating/oscillating in response to the driver signals 216a/216b having the multiple frequencies. Power profile determination module 902 can perform domain transformation operations (e.g., DFT, Z transform, etc.) on the current or voltage measurements to transform the measurements from the time domain to the frequency domain. For example, power profile determination module 902 can compute the DFT of N samples of current (I) and voltage (V) measurements as follows:

$${I}_{T} [ k ] = \frac{1}{N} {\sum }_{n = 0}^{N - 1} I [ n ] {e}^{- i \frac{2 π nk}{N}} \qquad ( Equation 12 )$$

$${V}_{T} [ k ] = \frac{1}{N} {\sum }_{n = 0}^{N - 1} V [ n ] {e}^{- i \frac{2 π nk}{N}} \qquad ( Equation 13 )$$

In Equations 12 and 13, I_{T}[k] and V_{T}[k] can represent DFT of the respective current and voltage measurement samples at a frequency index k, which is an integer and has a range between 0 to N−1. Each value of the frequency index can be mapped to a frequency in the frequency list. Power profile determination module 902 can repeat the computations of Equations 12 and 13 for different frequency index values, and then generate power profile 904 by mapping the current/voltage DFT coefficients to different frequencies in the frequency list.

Also, power profile determination module 902 can compute the apparent power magnitude value (181), true power value (P), and/or reactive power value (Q) in the frequency domain. Power profile determination module 902 can perform domain transform operations (e.g., DFT or Z transform operations) on the current or voltage measurements of transducer 102 to transform the measurements from the time domain to the frequency domain, and compute the real and imaginary components of impedance of transducer 102 in the frequency domain based on the transformed current/voltage measurements. Power profile determination module 902 can then compute the apparent power magnitude value (SD, true power value (P), and/or reactive power value (Q) in the frequency domain based on combining the real and imaginary components of impedance of transducer 102 with the transformed current measurements of transducer 102 in the frequency domain.

For example, power profile determination module 902 can compute the current and voltage DFT coefficients I_{T}[k] and V_{T}[k] (from Equations 12 and 13), and compute the DFT coefficients of impedance of transducer 102 (Z), and the real (Z_{R}) and imaginary component (Z_{I}) of the impedance Fourier transform coefficients, based on the current and voltage DFT coefficients I_{T}[k] and V_{T}[k] as follows:

$$Z [ k ] = \frac{{V}_{T} [ k ]}{{I}_{T} [ k ]} = \frac{{V}_{T} [ k ]}{{I}_{T} [ k ]} \times \frac{{I}_{T}^{⋆} [ k ]}{{I}_{T}^{⋆} [ k ]} = \frac{{V}_{T} [ k ] \times {I}_{T}^{⋆} [ k ]}{{( {I}_{T} [ k ] )}^{2}} = {Z}_{R} [ k ] + j \times {Z}_{I} [ k ] \qquad ( Equation 14 )$$

In Equation 14, I_{T}[k] and V_{T}[k] can represent DFT coefficients of the respective transformed current and voltage measurement samples at a frequency index k, and I_{T} [k] can represent a conjugate of the current DFT coefficient I_{T}[k]. Power profile determination module 902 can compute Z_{R}[k] and Z_{I}[k] from I_{T}[k] and V_{T}[k] for each frequency index k between 0 to N−1.

In some examples, power profile determination module 902 can also compute Z_{R} and Z_{I} based on the real and imaginary components of the real and imaginary components of the current and voltage DFT coefficients as follows:

$${Z}_{R} [ k ] = \frac{1}{{( {I}_{T} [ k ] )}^{2}} ( {V}_{TR} [ k ] \times {I}_{TR} [ k ] + {V}_{TI} [ k ] \times {I}_{TI} [ k ] ) \qquad ( Equation 15 )$$

$${Z}_{I} [ k ] = \frac{1}{{( {I}_{T} [ k ] )}^{2}} ( {V}_{TI} [ k ] \times {I}_{TR} [ k ] - {V}_{TR} [ k ] \times {I}_{TI} [ k ] ) \qquad ( Equation 16 )$$

In Equations 15 and 16, V_{TR}[k] and V_{TI}[k] can represent the respective real and imaginary component of the voltage DFT coefficient V_{T}[k]. Also, I_{TR}[k] and I_{TI}[k] can represent the respective real and imaginary component of the current DFT coefficient I_{T}[k].

Power profile determination module 902 can then compute, for each frequency index k, the Fourier transform coefficients of apparent power magnitude value (|S|), true power value (P), and/or reactive power value (Q) based on the current DFT coefficient I_{T}[k], impedance DFT coefficient Z[k], and the real and imaginary component of the impedance DFT coefficient Z_{R}[k] and Z_{I}[k] as follows:

S[k]=(I_{T}[k])²×Z[k]=(I_{T}[k])²×Z_{R}[k]+j×(I_{T}[k])²×Z_{I}[k] (Equation 17)

P[k]=(I_{T}[k])²×Z_{R}[k] (Equation 18)

Q[k]=(I_{T}[k])²×Z_{I}[k] (Equation 19)

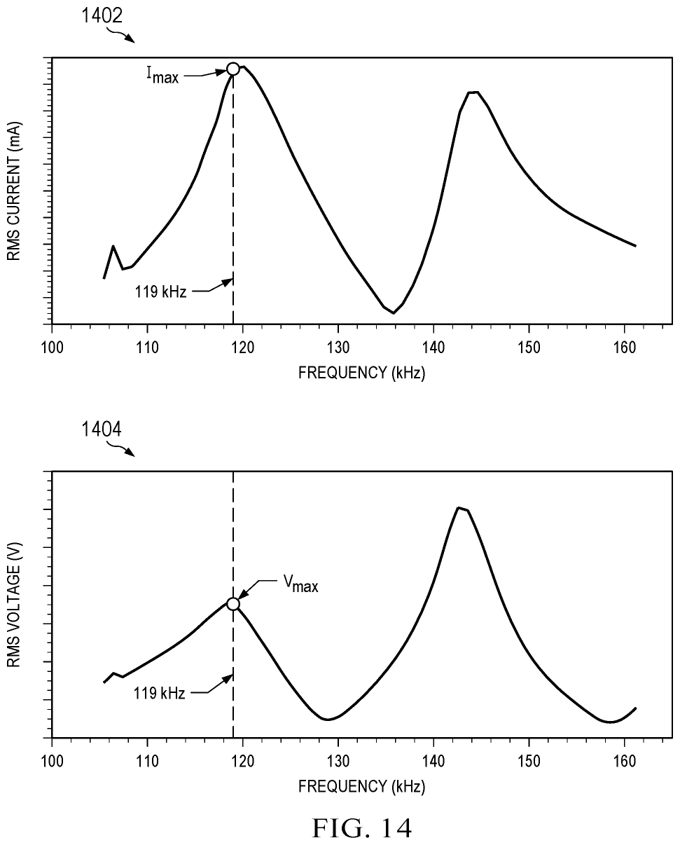

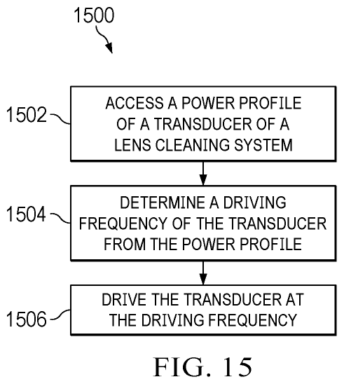

FIG. 15 is a flowchart of an example method 1500 of operating a lens cleaning system, such as lens cleaning system 900 of FIG. 9. Method 1500 can be performed by various components of lens cleaning system control circuit 130, such as controller 204, driver circuit 210, and sensor circuit 202.

In step 1502, controller 204 can access a power profile (e.g., power profile 904) of a transducer of the lens cleaning system (e.g., transducer 102).

As described above, power profile 904 can also be in the form of a mapping table and can include different memory addresses of memory 250 mapped to frequency values and to power metric values. An example of power profile 904 is illustrated in FIG. 10A. In some examples, the power profile can be part of a combined power and impedance profile, such as combined profile 1002 of FIG. 10B.

The power metrics are indicative of an amount of power transferred to transducer 102. Examples of power metrics can include a power value representing a power measurement, a current value representing a current measurement, and/or a voltage value representing a voltage measurement. Examples of a power value can include an apparent power magnitude value (ISI), a reactive power value (Q), and/or a true power value (P). Examples of power profile 904 are illustrated in FIGS. 11, 13, and 14.

In step 1504, controller 204 can determine a driving frequency of the transducer from the power profile. The driving frequency can be selected to maximize the power transfer to transducer 102. Controller 204 can traverse the memory addresses listed in power profile 904 to select oscillation frequencies within an operation frequency range and power metric values mapped to the selected frequencies, identify a power metric value indicating maximum power transfer to transducer 102, and identify the oscillation frequency mapped to the identified power metric value as the driving frequency. Controller 204 can identify the driving frequency based on the power metric value indicating maximum power transfer. For example, if power metric value includes a voltage value, a current value, an apparent power magnitude value (SD, or a true power value (P), controller 204 can identify the frequency mapped to the maximum power metric value (within the operation frequency range) as the driving frequency. Also, if power metric value includes a reactive power value (Q), controller 204 can identify the frequency mapped to the minimum power metric value within the operation frequency range) as the driving frequency.

In step 1506, controller 204 can drive the transducer at the driving frequency. The driving of the transducer can be performed to vibrate lens 104 and to remove objects (e.g., dust and water) from outer lens surface 107a. Controller 204 can set the frequency of control signal 212 to be equal to the driving frequency, and provide control signal 212 having the driving frequency to driver circuit 210. Driver circuit 210 can then provide driver signals 216a and 216b as a sinusoidal signal or a PWM signal to drive transducer 102 at the driving frequency. Examples of control signal 212 and driver signals 216a/216b are illustrated in FIG. 5. In some examples, lens cleaning system 900 can include filter circuit 220 coupled between driver circuit 210 and transducer 102 to filter the driver signals 216a/216b, such that the filtered driver signals 216a/216b can be sinusoidal signals having the same frequency as control signal 212.

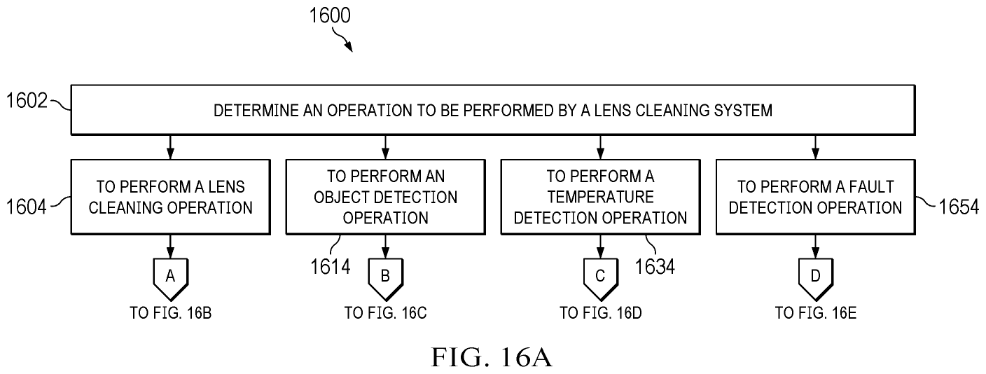

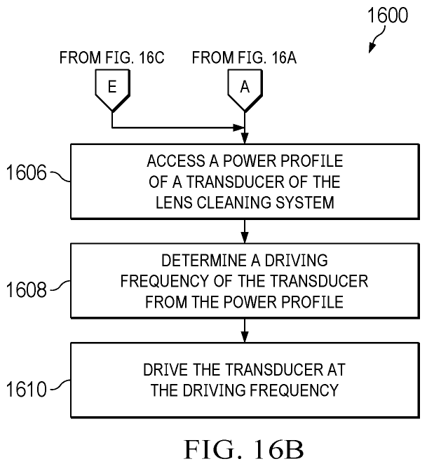

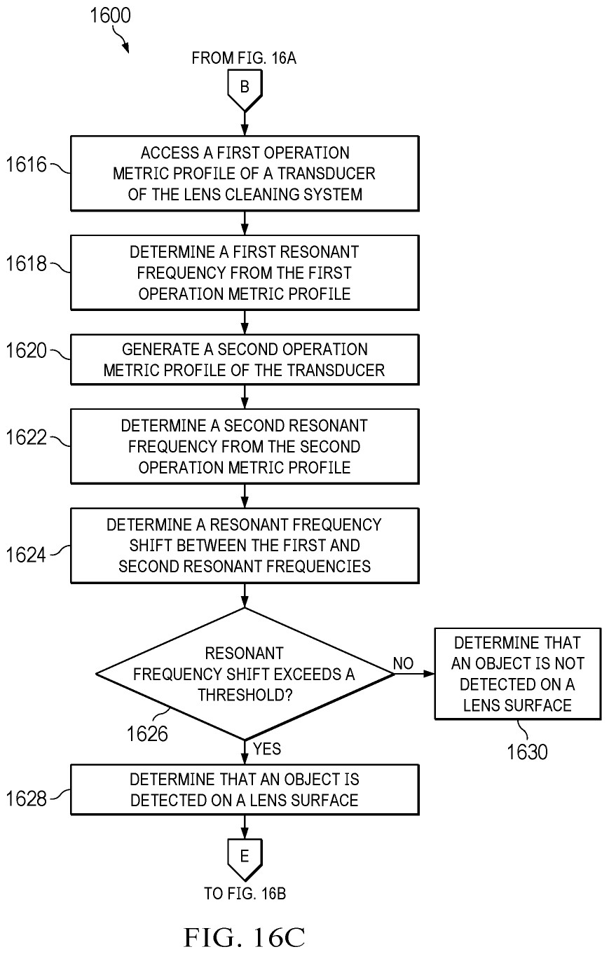

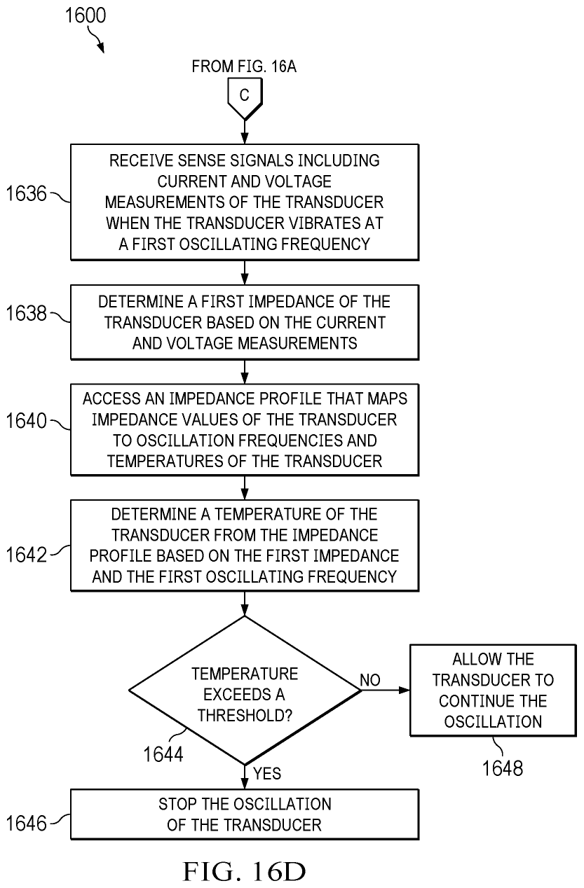

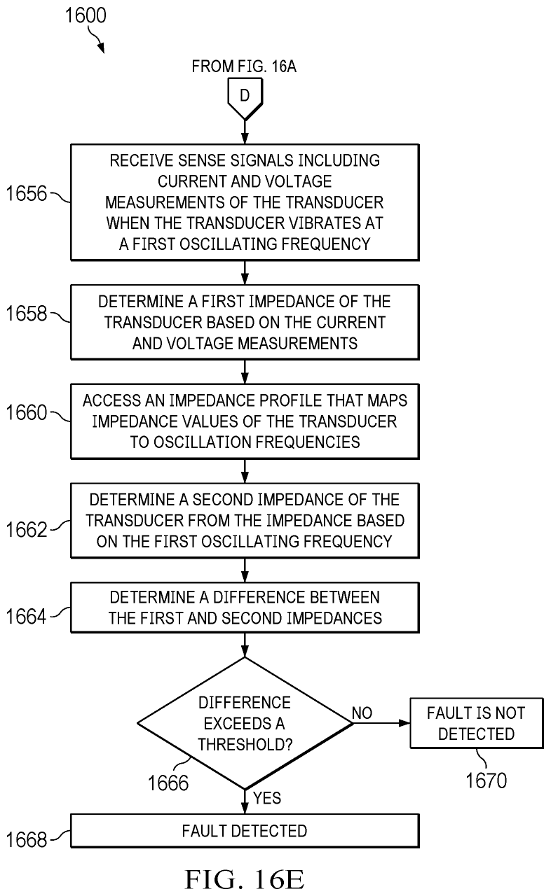

FIGS. 16A through 16E are flowcharts of an example method 1600 of operating a lens cleaning system, such as lens cleaning system 900 of FIG. 9. Method 1600 can be performed by various components of lens cleaning system control circuit 130, such as controller 204, driver circuit 210, and sensor circuit 202. Lens cleaning system 900 can store and/or maintain power profile 904 and impedance profile 240 in memory 250. In some examples, lens cleaning system 900 can also store and/or maintain a combined profile 1002 of power metric and impedance values. Impedance profile 240 can map between the impedance values and oscillation frequencies of transducer 102. As described above, the frequency of maximum power transfer in power profile 904 may be different from the frequency of minimum impedance in impedance profile 240.

In step 1602, controller 204 can determine an operation to be performed by the lens cleaning system. In some examples, the operation can be selected from a lens cleaning operation (step 1604), an object detection operation (step 1614), a temperature detection operation (step 1634), and a fault detection operation (step 1654). In some examples, controller 204 can start a particular operation responsive to, for example, receiving an external signal from an input interface coupled to camera lens assembly 100, or the expiration of a timer to trigger the module that performs the operation. In some examples, controller 204 can also start an operation responsive to the output of another operation, or to support another operation. For example, controller 204 can start a lens cleaning operation responsive to the result of an objection detection operation indicating that an external object is detected on the external lens surface.

In step 1604, controller 204 determines that a lens cleaning operation is to be performed. Referring to FIG. 16B, to perform the lens cleaning operation, controller 204 (e.g., lens cleaning module 206) can proceed to step 1606 to access a power profile of a transducer, followed by step 1608 to determine a driving frequency of the transducer from the power profile, and step 1610 to drive the transducer at the driving frequency. The operations of steps 1606 through 1610 can be identical to the respective steps 1502 through 1506 of method 1500 of FIG. 15.

Referring again to FIG. 16A, in step 1614, controller 204 determines that an object detection operation is to be performed. Referring to FIG. 16C, to perform the object detection operation, controller 204 (e.g., object detection module 252) can proceed to step 1616, in which controller 204 can access a first operation metric profile, such as a first power profile (e.g., power profile 904 from memory 250) or a first impedance profile (e.g., impedance profile 240 from memory 250), and determine a first resonant frequency from the first operation metric profile in step 1618. The first resonant frequency can be a frequency mapped to a power metric indicating a maximum amount of power delivered to transducer 102 when transducer 102 oscillates at that frequency, or can be a frequency mapped to a minimum impedance of transducer 102. The power metric can indicate a maximum voltage, a maximum current, a maximum apparent power, a maximum true power, or a minimum reactive power in the first power profile within an operation frequency range.

Controller 204 can also generate a second operation metric profile of the transducer, in step 1620. Controller 204 can trigger impedance profile determination module 232 or power profile determination module 902 to repeat a calibration operation to generate an updated respective impedance profile 240 or power profile 904. As described above, if an object is present on outer lens surface 107a, the additional mass can change the natural frequency of lens 104 and transducer 102, which can lead to a resonant frequency shift. As part of the calibration operation, power profile determination module 902 can cause driver control module 208 to drive transducer 102 at a set of frequencies according to a frequency list, and obtain the current and/or voltage measurements of transducer 102 vibrating/oscillating at the set of frequencies from sensor circuit 202. Controller 204 can generate the second operation metric profile, such as a second power profile or a second impedance profile, using time domain or frequency domain computations as described above.

After generating the second operation metric profile, controller 204 can proceed to step 1622 and determine a second resonant frequency from the second operation metric profile. The second resonant frequency can be the frequency mapped to a power metric indicating a maximum amount of power delivered to transducer 102 (e.g., a maximum voltage, a maximum current, a maximum apparent power magnitude value, a maximum true power value, or a minimum reactive power value) or a minimum impedance of transducer 102 in the second operation metric profile within an operation frequency range.

In step 1624, controller 204 can determine a resonant frequency shift between the first and second resonant frequencies. The resonant frequency shift can be based on, for example, a difference between the first and second resonant frequencies.

In step 1626, controller 204 can determine whether the resonant frequency shift exceeds a threshold. If the resonant frequency shift exceeds the threshold, controller 204 can determine that an object is detected on the lens surface, in step 1628. Controller 204 can then trigger lens cleaning module 206 to start a lens cleaning operation (FIG. 16B), in which lens cleaning module 206 can cause driver circuit 210 to drive transducer 102 at the second resonant frequency to remove the detected object. On the other hand, if controller 204 determines that an object is not detected on the lens surface (step 1626), controller 204 can determine that an object is not on a lens surface in step 1630, and set control signal 212 in an inactive state to suspend the vibration of transducer 102 to conserve energy.

Referring again to FIG. 16A, in step 1634, controller 204 determines that a temperature detection operation is to be performed. Referring to FIG. 16D, controller 204 (e.g., temperature detection module 251) can proceed to step 1636 and receive sense signals including current and voltage measurements of transducer 102 from sensor circuit 202 when the transducer vibrates/oscillates at a first oscillating frequency. For example, controller 204 can receive the current and voltage measurements during the lens cleaning operation, and the first oscillating frequency can be the frequency mapped to a maximum power metric in power profile 904.

In step 1638, controller 204 can determine a first impedance of transducer 102 based on the current and voltage measurements. For example, controller 204 can determine RMS values of the current and voltage measurements, and determine the first impedance based on a ratio between the RMS value of the voltage measurements and the RMS value of the current measurements.

In step 1640, controller 204 can access an impedance profile, such as impedance profile 240, and determine a first temperature of transducer 102 from the impedance profile based on the first oscillating frequency and the first impedance. For example, as illustrated in FIG. 6B, impedance profile 240 can map impedance values of the transducer 102 to oscillation frequencies and temperatures of the transducer. In some examples, controller 204 can traverse the memory addresses listed in impedance profile 240 to find a mapping including the first oscillating frequency and the first temperature, and determine the first temperature from the mapping. In some examples, controller 204 can also identify multiple mappings including oscillating frequencies and impedances that are within certain ranges from the respective first oscillating frequency and first impedances, and determine the first temperature by extrapolating from the temperatures included in the mappings.

In step 1644, controller 204 can determine whether the temperature exceeds a threshold. The threshold can be based on a Curie temperature of transducer 102. If the temperature exceeds the threshold, controller 204 can stop the oscillation of transducer 102 (and the lens cleaning operation) to avoid depolarizing the transducer, in step 1646. If the temperature does not exceed the threshold, controller 204 can allow the oscillation of transducer (and the lens cleaning operation) to continue, in step 1648.

Referring again to FIG. 16A, in step 1654, controller 204 determines that a fault detection operation is to be performed. Referring to FIG. 16E, controller 204 (e.g., fault detection module 254) can proceed to step 1656 and receive sense signals including current and voltage measurements of transducer 102 from sensor circuit 202 when the transducer vibrates/oscillates at a first oscillating frequency. For example, controller 204 can receive the current and voltage measurements during the lens cleaning operation, and the first oscillating frequency can be the frequency mapped to a maximum power metric in power profile 904.

In step 1658, controller 204 can determine a first impedance of transducer 102 based on the current and voltage measurements. For example, controller 204 can determine RMS values of the current and voltage measurements, and determine the first impedance based on a ratio between the RMS value of the voltage measurements and the RMS value of the current measurements.

In step 1660, controller 204 can access an impedance profile, such as impedance profile 240 that maps between impedance values and oscillation frequencies of the transducer, and determine a second impedance of the transducer. The second impedance can be a reference/target impedance of transducer 102 when oscillating at the first oscillation frequency. Controller 204 can obtain a value of the second impedance mapped to the first oscillation frequency from impedance profile 240, or by interpolating from impedance values mapped to oscillating frequencies that are within a range from the first oscillating frequency.

In step 1664, controller 204 can determine a difference between the first and second impedances. For example, controller 204 can find a magnitude difference between the respective first and second impedances.

In step 1666, controller 204 can determine whether the difference exceeds a threshold. If the difference exceeds a threshold, controller 204 can determine that a fault condition is detected, in step 1668. Controller 204 can perform various operations responsive to detecting the fault condition, such as stopping the lens cleaning operation and outputting a signal indicating a fault condition. If the difference does not exceed the threshold, controller 204 can determine that the fault condition is not detected, in step 1670. Controller 204 can allow the lens cleaning operation (and the oscillation of transducer 102) to continue responsive to not detecting the fault condition.

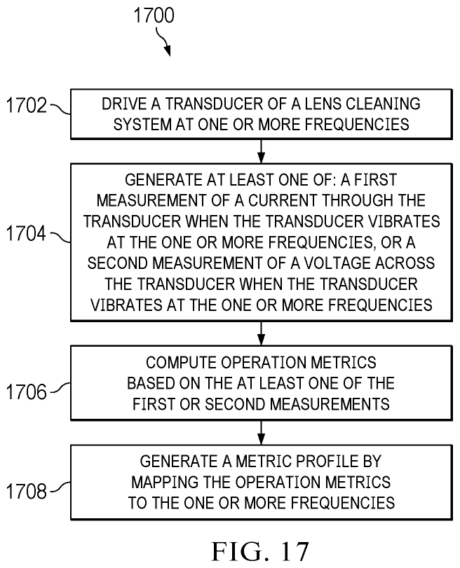

FIG. 17 is a flowchart of an example method 1700 of calibrating a lens cleaning system, such as lens cleaning system 900 of FIG. 9. The calibration operation can be performed to generate a metric profile that relates between the operation metric and oscillation frequencies of transducer 102. The metric profile can include impedance profile 240 and power profile 904. Method 1700 can be performed by various components of lens cleaning system control circuit 130, such as controller 204 (e.g., impedance profile determination module 232 and power profile determination module 902), driver circuit 210, and sensor circuit 202. Lens cleaning system 900 can include transducer 102.

In step 1702, controller 204 can drive transducer 102 at one or more frequencies. Also, in step 1704, controller 204 can generate at least one of: a first measurement of a current through the transducer when the transducer vibrates at the one or more frequencies, or a second measurement of a voltage across the transducer when the transducer vibrates at the one or more frequencies.

Specifically, driver control module 208 can provide control signal 212 at one or more frequencies to driver circuit 210, which can provide driver signals 216a/216b to set the frequency of oscillation of transducer 102. Driver signals 216a/216b can be in the form of PWM signals or sinusoidal signals. Controller 204 can receive sense signals 230 including a measurement of a current through transducer 102 and/or a measurement of a voltage across transducer 102. Both measurements can be made when transducer 102 vibrates at the oscillation frequency set by driver signals 216a/216b.

Impedance profile determination module 232 and power profile determination module 902 can generate respective impedance profile 240 and power profile 904 based on time domain or frequency domain computations. With time domain computation, impedance profile determination module 232 and power profile determination module 902 can cause driver control module 208 to provide control signal 212 having a single frequency at a time, and receive the voltage and/or current measurements of transducer 102 vibrating/oscillating at that frequency. With frequency domain computation, impedance profile determination module 232 and power profile determination module 902 can cause driver control module 208 to provide multiple control signals 212 having multiple frequencies, and obtain the voltage and/or current measurements of transducer 102 vibrating/oscillating at the multiple frequencies.

In step 1706, controller 204 can compute a first operation metric at the first frequency based on at least one of the current or voltage measurements.

Specifically, for time domain computation of a power metric including only a voltage value or a current value, controller 204 can compute an RMS value of the current measurements or an RMS value of the voltage measurements. Further, for time domain computation of a power metric including a power value indicating an amount of power delivered to transducer 102, controller 204 can compute a true power value (P), an apparent power magnitude value (ISI), or a reactive power value (Q) based on the current and voltage measurements according to Equations 6 to 11 described above.

Also, with frequency domain computation, controller 204 can compute a set of impedance metrics and power metrics for the multiple frequencies. For example, controller 204 can perform domain transformation operations (e.g., Discrete Fourier Transform operations or Z transform operations) on the voltage and current measurements to transform the measurements from time domain representations to frequency domain representations, and compute the impedance values in the frequency domain based on a ratio between the transformed voltage and current measurements. Also, controller 204 can compute the transformed voltage or current measurements as the power metrics. Controller 204 can also compute the apparent power, true power, and reactive power in frequency domain by computing the impedance values in frequency domain based on a ratio between the transformed voltage and current measurements, and combining the impedance values in frequency domain with the transformed current measurements, according to Equations 14 to 19 described above.

In step 1708, controller 204 can generate a metric profile by mapping operation metrics including the first operation metric to a set of frequencies including the first frequency. With time domain computation, controller 204 can repeat steps 1702 to 1706 by driving transducer 102 at different oscillation frequencies according to a frequency list, and generate the operation metrics (impedance metrics or power metrics) for the different oscillation frequencies. Controller 204 can then generate the metric profile by mapping the operation metrics to the oscillation frequencies, and store the metric profile in a memory (e.g., memory 250). With frequency domain computation, controller 204 can generate a set of impedance or power metrics in frequency domain representation, such as DFT coefficients mapped to different frequency indices. Controller 204 can then generate the metric profile by mapping the different frequency indices to the different oscillation frequencies in the frequency list, to map the operation metrics to the oscillation frequencies.

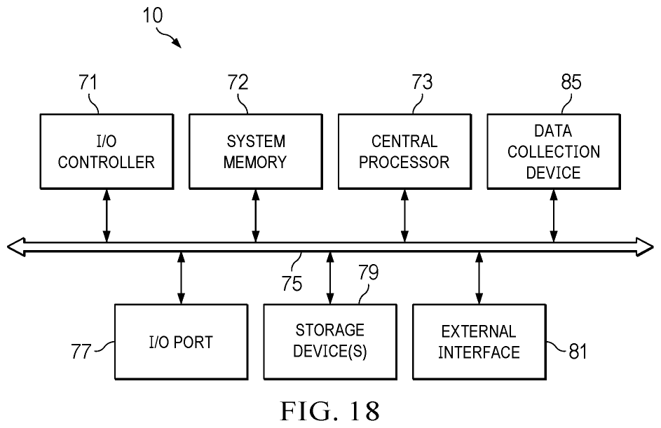

Any of the computing systems mentioned herein may utilize any suitable number of subsystems. Examples of such subsystems are shown in FIG. 18 in a hardware computing system which can be part of lens cleaning systems 200 and 800. For example, hardware computing system 10 can be part of lens cleaning system control circuit 130.

The subsystems shown in FIG. 18 are interconnected via a system bus 75 (e.g., eUSB, I2C, FPDLink, etc.). Additional subsystems such as storage device(s) 79 and others are shown. Peripherals and input/output (I/O) devices, which couple to I/O controller 71, can be connected to the hardware computing system by any number of means such as input/output (I/O) port 77 (e.g., USB, SPI, CAN, FireWire®). For example, I/O port 77 or external interface 81 (e.g. Ethernet, Wi-Fi, etc.) can be used to connect hardware computing system 10 to a wide area network such as the Internet, or an input device. For example, I/O port 77 can provide an external signal to controller 204 to trigger a calibration operation, a lens cleaning operation, a temperature detection operation, an object detection operation, or a fault detection operation. The interconnection via system bus 75 allows the central processor 73 to communicate with each subsystem and to control the execution of a plurality of instructions from system memory 72 or the storage device(s) 79 (e.g., a fixed disk, such as a hard drive, or optical disk), and the exchange of information between subsystems. The system memory 72 (e.g. RAM, ROM, etc.) and/or the storage device(s) 79 may embody a computer readable medium. In some examples, system memory 72 can represent memory 250 of FIG. 2 and FIG. 9.

In some examples, central processor 73 can be part of controller 204, which can execute instructions stored in system memory 72 and/or storage device(s) 79 to perform the example methods described above in FIG. 15 through FIG. 17, and use system memory 72 to store the input data, output data, as well as intermediary data generated from the performance of the methods (e.g., impedance profile 240 and power profile 904. Another subsystem is a data collection device 85, such as sensor circuit 202. Data collection device 85 can store the data (e.g., samples of current and voltage measurements) at system memory 72. Any of the data described herein can be output from one component to another component and can be provided to the user.

A hardware computing system can include the same components or subsystems, e.g., connected together by external interface 81 or by an internal interface. In some embodiments, hardware computing systems, subsystem, or apparatus can communicate over a network. In such instances, one computer can be a client and another computer a server, where each can be part of a same computer system. A client and a server can each include multiple systems, subsystems, or components.

Aspects of embodiments herein can be implemented in the form of control logic using hardware (e.g. an application specific integrated circuit or field programmable gate array) and/or using computer software with a generally programmable processor in a modular or integrated manner. As used herein, a processor includes a single-core processor, multi-core processor on a same integrated chip, or multiple processing units on a single circuit board or networked.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computing system), and may be present on or within different computer products within a system or network. A computing system may include a monitor, printer, or other suitable display for providing any of the results mentioned herein to a user.

Any of the methods described herein may be totally or partially performed with a computing system including one or more processors, which can be configured to perform the steps. Thus, embodiments can be directed to computing systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, any of the steps of any of the methods can be performed with modules, units, circuits, or other means for performing these steps.

In this description, the term “couple” may cover connections, communications or signal paths that enable a functional relationship consistent with this description. For example, if device A provides a signal to control device B to perform an action, then: (a) in a first example, device A is directly coupled to device B; or (b) in a second example, device A is indirectly coupled to device B through intervening component C if intervening component C does not substantially alter the functional relationship between device A and device B, so device B is controlled by device A via the control signal provided by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

A circuit or device that is described herein as including certain components may instead be adapted to be coupled to those components to form the described circuitry or device. For example, a structure described herein as including one or more semiconductor elements (such as transistors), one or more passive elements (such as resistors, capacitors and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, such as by an end-user and/or a third party.

Certain components may be described herein as being of a particular process technology, but these components may be exchanged for components of other process technologies. Circuits described herein are reconfigurable to include the replaced components to provide functionality at least partially similar to functionality available prior to the component replacement. Components shown as resistors, unless otherwise stated, are generally representative of any one or more elements coupled in series and/or parallel to provide an amount of impedance represented by the shown resistor. For example, a resistor or capacitor shown and described herein as a single component may instead be multiple resistors or capacitors, respectively, coupled in series or in parallel between the same two nodes as the single resistor or capacitor.

As used herein, the terms “terminal”, “node”, “interconnection”, “pin”, “ball”, “electrode” and “lead” are used interchangeably. Unless specifically stated to the contrary, these terms are generally used to mean an interconnection between or a terminus of a device element, a circuit element, an integrated circuit, a device or other electronics or semiconductor component. While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board. The term “module” may be used to describe a circuit and/or an integrated circuit, or “module” may be used as a separately packaged circuit.

Uses of the phrase “ground voltage potential” and/or “ground” in this description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter, or, if the value is zero, a reasonable range of values around zero.

Modifications are possible in the described examples, and other examples are possible, within the scope of the claims.

What is claimed is:

1. An apparatus comprising:
a transducer;
a driver circuit coupled to the transducer;
a memory configured to store a power profile, the power profile including a mapping between power metrics and oscillation frequencies of the transducer, the power metrics being indicative of a power delivered to the transducer; and
a controller coupled to the memory and the driver circuit, the controller configured to:
obtain the power profile from the memory;
determine a frequency of a driver signal based on the power profile; and
provide the driver signal having the frequency to the driver circuit.

2. The apparatus of claim 1, wherein the controller is configured to determine the frequency based on a first power metric mapped to the frequency indicating a maximum amount of power delivered to the transducer relative to other power metrics mapped to other frequencies of a frequency range in the power profile.

3. The apparatus of claim 2, further comprising a filter circuit coupled between the driver circuit and the transducer,
wherein the first power metric indicates the maximum amount of power delivered to the driver circuit and to the transducer within the frequency range.

4. The apparatus of claim 1, wherein each of the power metrics represents a voltage across the transducer.

5. The apparatus of claim 1, wherein each of the power metrics represents a current through the transducer.

6. The apparatus of claim 1, wherein each of the power metrics represents an amount of power consumed by or rejected by the transducer.

7. The apparatus of claim 6, wherein each of the power metrics represents at least one of: an apparent power, a true power, or a reactive power.

8. The apparatus of claim 1, further comprising a lens mechanically coupled to the transducer,
wherein the transducer is configured to vibrate the lens responsive to the driver signal to remove an object on a surface of the lens.

9. The apparatus of claim 8, further comprising a sensor circuit coupled to the transducer and to the controller;
wherein the power profile is a first power profile, the frequency is a first frequency, and the controller is configured to:
provide driver signals having a set of frequencies to the driver circuit;
receive sense signals from the sensor circuit, the sense signals representing at least one of a first measurement of a voltage across the transducer when the transducer vibrates responsive to the driver signals, or a second measurement of a current through the transducer when the transducer vibrates responsive to the driver signals,
generate a second power profile based on the at least one of the first or second measurements;
determine a second frequency from the second power profile;
determine a frequency difference between the first and second frequencies;
determine whether the object is on the surface of the lens based on the frequency difference; and
responsive to determining that the object is on the surface of the lens, provide the driver signal having the second frequency to remove the object.

10. The apparatus of claim 9, wherein the mapping is a first mapping and the memory is configured to store an impedance profile, the impedance profile including a second mapping between impedances and the oscillation frequencies of the transducer.

11. The apparatus of claim 10, wherein the impedances are mapped to temperatures of the transducer; and
wherein the controller is configured to access the impedance profile to determine a temperature of the transducer.

12. The apparatus of claim 11, wherein the controller is configured to:
determine whether the temperature exceeds temperature threshold; and
responsive to determining that the temperature exceeds the temperature threshold, set the driver signal in an inactive state to stop a vibration of the transducer.

13. The apparatus of claim 10,
wherein the impedance profile is a first impedance profile, the frequency difference is a first frequency difference, and the controller is configured to:
determine a third frequency from the first impedance profile;
generate a second impedance profile based on the first and second measurements;
determine a fourth frequency from the second power profile;
determine a second frequency difference between the third and fourth frequencies;
determine whether the object is on the surface of the lens based on the second frequency difference; and
responsive to determining that the object is on the surface of the lens, provide the driver signal having the fourth frequency to remove the object.

14. The apparatus of claim 10, wherein the controller is configured to:
determine a first impedance of the transducer when vibrating at the first frequency based on the sense signals;
determine a second impedance of the transducer from the impedance profile based on the first frequency;
determine an impedance difference between the first and second impedances;
determine whether a fault condition occurs based on the impedance difference; and
responsive to determining that the fault condition occurs, perform at least one of: outputting an indication of the fault condition, or setting the driver signal in an inactive state to stop a vibration of the transducer.

15. The apparatus of claim 10, wherein the controller is configured to:
perform a first calibration operation to generate the impedance profile; and
perform a second calibration operation to generate the power profile.

16. The apparatus of claim 15, wherein the controller is configured to perform the first and second calibration operations responsive to at least one of: periodic expiration of a timer, or an external signal.

17. The apparatus of claim 15, wherein the controller is configured to, as part of the first and second calibration operations:
receive a frequency list;
for each frequency on the frequency list:
provide the driver signal having the frequency to the driver circuit;
receive the sense signals from the sensor circuit representing at least one of the first or second measurements of the transducer vibrating at the frequency; and
determine at least one of an impedance value or a power metric based on the at least one of the first or second measurements; and
generate the power profile by mapping the power metrics to the frequencies on the frequency list; and
generate the impedance profile by mapping the impedance values to the frequencies on the frequency list.

18. The apparatus of claim 15, wherein the controller is configured to, as part of the first and second calibration operations:
provide driver signals having a set of frequencies to the driver circuit;
receive the sense signals from the sensor circuit representing at least one of the first or second measurements of the transducer vibrating at the set of frequencies;
perform transform operations to transform the at least one of the first or second measurements from a time domain to a frequency domain; and
generate the power profile and the impedance profile based on the transformed at least one of the first or second measurements in the frequency domain.

19. A method comprising:
determining an operation to be performed by a lens cleaning system;
accessing, based on the operation, one of a power profile or an impedance profile of the lens cleaning system, in which the power profile includes a first mapping between power metrics and oscillation frequencies of a transducer of the lens cleaning system, the power metrics being indicative of a power delivered to the transducer, and the impedance profile includes a second mapping between impedances and the oscillation frequencies of the transducer;
determining a driving frequency of the transducer of the lens cleaning system from the one of the power profile or the impedance profile; and
driving the transducer at the driving frequency.

20. The method of claim 19, wherein the driving frequency is a first driving frequency, and the method further comprises:
determining the first driving frequency from the power profile;
determining a second driving frequency from the impedance profile;
driving the transducer at the first driving frequency to support a lens cleaning operation and an object detection operation; and
driving the transducer at the second driving frequency to support a temperature detection operation and a fault detection operation.

21. A method comprising:
driving a transducer of a lens cleaning system at one or more frequencies;
generating a first measurement of a current through the transducer when the transducer vibrates at the one or more frequencies, or a second measurement of a voltage across the transducer when the transducer vibrates at the one or more frequencies;
computing operation metrics based on at least one of the first or second measurements; and
generating a metric profile by mapping the operation metrics to the one or more frequencies.

22. The method of claim 21, wherein the operation metrics include power metrics each indicative of an amount of power delivered to the transducer.

23. The method of claim 22, wherein each of the power metrics represents at least one of: a voltage across the transducer, a current through the transducer, an apparent power, a true power, or a reactive power.

24. The method of claim 21, wherein the operation metrics include impedance values representing an impedance of the transducer.
